(19) United States
(12) Patent Application Publication
(10) Pub. No.: US 2024/0065130 A1
(43) Pub. Date: Feb. 29, 2024

(54) DISC BLADE ANGLE ADJUSTMENT SYSTEM FOR A TILLAGE IMPLEMENT

(71) Applicant: CNH Industrial America LLC, New Holland, PA (US)

(72) Inventors: Heath A. Toennies, Eureka, IL (US); Timothy Richard Blunier, Danvers, IL (US); Sven Nathaniel Setterdahl, Maquon, IL (US); Jared Paul Schaffer, Normal, IL (US)

(21) Appl. No.: 17/900,257

(22) Filed: Aug. 31, 2022

(51) Int. Cl. A01B 63/32; A01B 35/16; A01B 63/24

(52) U.S. Cl. CPC A01B 63/32; A01B 35/16; A01B 63/245

(57) ABSTRACT

A disc blade angle adjustment system for a tillage implement includes a first actuator having a cylinder, a piston disposed within the cylinder, and a single rod extending from the piston. The first actuator is configured to couple to a frame of the tillage implement and to a first disc blade support. The disc blade angle adjustment system also includes a second actuator having a cylinder, a piston disposed within the cylinder, and a single rod extending from the piston. The second actuator is configured to couple to the frame of the tillage implement and to a second disc blade support. In addition, the disc blade angle adjustment system includes a conduit extending between a cap end of the first actuator and a cap end of the second actuator or between a rod end of the first actuator and a rod end of the second actuator.

### BACKGROUND

The present disclosure relates to a disc blade angle adjustment system for a tillage implement.

Certain agricultural implements include ground engaging tools configured to interact with soil. For example, a tillage implement may include disc blades configured to break up the soil for subsequent planting or seeding operations. Groups of disc blades may be arranged in gangs, and each gang of disc blades may be rotatably coupled to a frame of the tillage implement. In certain tillage implements, an angle of each gang may be adjustable relative to the frame, thereby facilitating adjustment of the angle of the disc blades of the gang relative to a direction of travel of the tillage implement. For example, the gang of disc blades may be rotatably coupled to a gang support, and the gang support may be pivotally coupled to the frame of the tillage implement. Accordingly, the angle of the disc blades of the gang relative to the direction of travel may be adjusted by rotating the gang support relative to the frame.

In certain tillage implements, a gang angle adjustment system is configured to control the pivotal movement of the gang supports. For example, the gang angle adjustment system may include hydraulic actuators configured to drive the gang supports to pivot, thereby controlling the angle of the disc blades relative to the direction of travel of the tillage implement. Unfortunately, certain hydraulic gang angle adjustment systems lack the ability to independently adjust the gangs by row, or utilize multiple work vehicle remote valves to accomplish the task. Other hydraulic gang angle adjustment systems lack synchronized adjustment and rely on physical hard stops to set the operating positions of the gangs.

### BRIEF DESCRIPTION

In certain embodiments, a disc blade angle adjustment system for a tillage implement includes a first actuator having a cylinder, a piston disposed within the cylinder, and a single rod extending from the piston. The first actuator is configured to couple to a frame of the tillage implement and to a first disc blade support, the first disc blade support is configured to pivotally couple to the frame at a first pivot point, the first disc blade support is configured to support a first set of disc blades, and the first actuator is configured to drive the first disc blade support to pivot relative to the frame to control a first angle between the first set of disc blades and a direction of travel of the tillage implement. The disc blade angle adjustment system also includes a second actuator having a cylinder, a piston disposed within the cylinder of the second actuator, and a single rod extending from the piston of the second actuator. The second actuator is configured to couple to the frame of the tillage implement and to a second disc blade support, the second disc blade support is configured to pivotally couple to the frame at a second pivot point, the second disc blade support is configured to support a second set of disc blades, the first and second disc blade supports are configured to pivot independently of one another, and the second actuator is configured to drive the second disc blade support to pivot relative to the frame to control a second angle between the second set of disc blades and the direction of travel of the tillage implement. In addition, the disc blade angle adjustment system includes a conduit extending between a cap end of the first actuator and a cap end of the second actuator or between a rod end of the first actuator and a rod end of the second actuator. The conduit is configured to enable fluid flow between the first and second actuators. Furthermore, a cross-sectional area of the rod of the first actuator is substantially equal to a cross-sectional area of the rod of the second actuator, and an internal cross-sectional area of the cylinder of the first actuator is substantially equal to an internal cross-sectional area of the cylinder of the second actuator. In addition, the first actuator is configured to drive the first disc blade support to pivot in a first direction about the first pivot point in response to extension of the rod of the first actuator, the first actuator is configured to drive the first disc blade support to pivot in a second direction about the first pivot point, opposite the first direction, in response to retraction of the rod of the first actuator, the second actuator is configured to drive the second disc blade support to pivot in the second direction about the second pivot point in response to extension of the rod of the second actuator, and the second actuator is configured to drive the second disc blade support to pivot in the first direction about the second pivot point in response to retraction of the rod of the second actuator.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having a disc blade angle adjustment system;

FIG. 2 is a top view of a portion of the tillage implement of FIG. 1;

FIG. 3 is a top view of a front portion of the tillage implement of FIG. 1;

FIG. 4 is a top view of a rear portion of the tillage implement of FIG. 1; and

FIG. 5 is a schematic diagram of an embodiment of a disc blade angle adjustment system that may be employed within the tillage implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

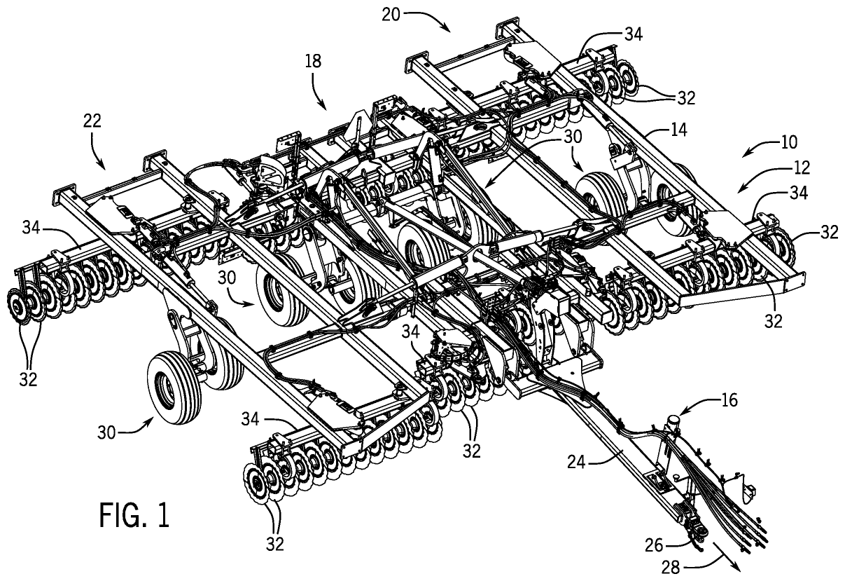

FIG. 1 is a perspective view of an embodiment of a tillage implement 10 having a disc blade angle adjustment system 12. In the illustrated embodiment, the tillage implement 10 is a vertical tillage implement having multiple ground engaging tools configured to till soil. As illustrated, the tillage implement 10 includes a frame 14 and a hitch assembly 16 coupled to the frame 14. In the illustrated embodiment, the frame 14 includes a center section 18, a left wing section 20, and a right wing section 22. Each wing section is configured to pivot upwardly from the illustrated working position to a transport position to facilitate transport of the tillage implement 10. For example, one or more actuators (e.g., hydraulic cylinder(s), etc.) may be configured to drive each wing section to pivot between the illustrated working position and the transport position. While the frame 14 includes the center section 18, the left wing section 20, and the right wing section 22 in the illustrated embodiment, in other embodiments, the frame may include more or fewer sections. For example, in certain embodiments, the frame may be substantially rigid (e.g., not including any translatable and/or rotatable components). Furthermore, the frame 14 may be formed from multiple frame elements (e.g., rails, tubes, braces, etc.) coupled to one another (e.g., via welded connection(s), via fastener(s), etc.).

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g., tractor), which is configured to tow the tillage implement 10 through a field along a direction of travel 28. While the hitch frame 24 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame and a wheel rotatably coupled to the wheel frame. The wheels of the wheel assemblies 30 are configured to engage the surface of the soil, and the wheel assemblies 30 are configured to support at least a portion of the weight of the tillage implement 10. In the illustrated embodiment, each wheel frame is pivotally coupled to the implement frame 14, thereby facilitating adjustment of the vertical position of the respective wheel(s). However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g., 1, 3, 4, 5, 6, or more). As used herein with respect to the tillage implement 10, “row” refers to an arrangement of disc blades 32 that extends along a direction crosswise to the direction of travel 28 and does not overlap another row along the direction of travel 28. Furthermore, in the illustrated embodiment, each row of disc blades 32 includes four gangs of disc blades 32. Two gangs of disc blades of the front row are coupled to the center section 18, two gangs of disc blades of the rear row are coupled to the center section 18, one gang of disc blades of the front row is coupled to the left wing section 20, one gang of disc blades of the rear row is coupled to the left wing section 20, one gang of disc blades of the front row is coupled to the right wing section 22, and one gang of disc blades of the rear row is coupled to the right wing section 22. While the tillage implement 10 includes eight gangs of disc blades 32 in the illustrated embodiment, in other embodiments, the tillage implement may include more or fewer gangs of disc blades (e.g., 2, 4, 6, 10, or more). Furthermore, the gangs of disc blades may be arranged in any suitable configuration on the implement frame.

The disc blades 32 of each gang are non-rotatably coupled to one another by a respective shaft, such that the disc blades 32 of each gang rotate together. Each shaft is rotatably coupled to a respective disc blade support 34, which is configured to support the gang, including the shaft and the disc blades 32. Furthermore, each disc blade support 34 is pivotally coupled to the frame 14 at a respective pivot point, thereby enabling the disc blade support 34 to pivot relative to the frame 14. In the illustrated embodiment, the disc blade supports 34 are configured to pivot independently of one another. However, in certain embodiments, at least two disc blade supports may be coupled to one another by linkage(s), such that the rotation of one disc blade support drives the rotation of one or more other disc blade supports. Rotating each disc blade support 34 relative to the frame 14 controls the angle between the respective disc blades 32 and the direction of travel 28, thereby controlling the interaction of the disc blades 32 with the top layer of the soil. Each disc blade support 34 may include any suitable structure(s) configured to support the respective gang (e.g., including a square tube, a round tube, a bar, a truss, other suitable structure(s), or a combination thereof). While the disc blades 32 supported by each disc blade support 34 are arranged in a respective gang (e.g., non-rotatably coupled to one another by a respective shaft) in the illustrated embodiment, in other embodiments, at least a portion of the disc blades supported by at least one disc blade support (e.g., all of the disc blades supported by the disc blade support) may be arranged in another suitable configuration (e.g., individually mounted and independently rotatable, mounted in groups and individually rotatable, etc.). For example, in certain embodiments, a first portion of the disc blades supported by a disc blade support may be arranged in a gang, and a second portion of the disc blades supported by the disc blade support may be individually mounted and independently rotatable.

In the illustrated embodiment, the rotation of each gang of disc blades 32 is controlled by a disc blade angle adjustment system 12. In certain embodiments, the disc blade angle adjustment system 12 includes a first actuator having a cylinder, a piston disposed within the cylinder, and a single rod extending from the piston. The first actuator is coupled to the frame 14 of the tillage implement 10 and to a first disc blade support 34, and the first actuator is configured to drive the first disc blade support 34 to pivot relative to the frame 14 to control a first angle between a first set of disc blades supported by the first disc blade support 34 and the direction of travel 28 of the tillage implement 10. In addition, the disc blade angle adjustment system 12 includes a second actuator having a cylinder, a piston disposed within the cylinder, and a single rod extending from the piston. The second actuator is coupled to the frame 14 of the tillage implement 10 and to a second disc blade support 34, and the second actuator is configured to drive the second disc blade support 34 to pivot relative to the frame 14 to control a second angle between a second set of disc blades supported by the second disc blade support 34 and the direction of travel 28 of the tillage implement 10. Furthermore, the disc blade angle adjustment system 12 includes a conduit extending between a cap end of the first actuator and a cap end of the second actuator or between a rod end of the first actuator and a rod end of the second actuator. The conduit is configured to enable fluid flow between the first and second actuators. In addition, a cross-sectional area of the rod of the first actuator is substantially equal to a cross-sectional area of the rod of the second actuator, and an internal cross-sectional area of the cylinder of the first actuator is substantially equal to an internal cross-sectional area of the cylinder of the second actuator. The first actuator is configured to drive the first disc blade support to pivot in a first direction about the first pivot point in response to extension of the rod of the first actuator, and the first actuator is configured to drive the first disc blade support to pivot in a second direction about the first pivot point, opposite the first direction, in response to retraction of the rod of the first actuator. In addition, the second actuator is configured to drive the second disc blade support to pivot in the second direction about the second pivot point in response to extension of the rod of the second actuator, and the second actuator is configured to drive the second disc blade support to pivot in the first direction about the second pivot point in response to retraction of the rod of the second actuator. Because each actuator includes a single rod extending from the piston, the cost of each actuator may be reduced, and the longevity of each actuator may be increased (e.g., due to fewer seals), as compared to an actuator having a first rod extending in a first direction from the piston and a second rod extending in a second direction, opposite the first direction, from the piston.

While the tillage implement includes the disc blades 32 in the illustrated embodiment, in other embodiments, the tillage implement may include other/additional ground engaging tool(s) (e.g., coupled to the disc blade support(s), coupled to the frame of the tillage implement, etc.). For example, in certain embodiments, the tillage implement may include tillage point assemblies (e.g., positioned behind the disc blades relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), finishing reel(s), other suitable ground engaging tool(s), or a combination thereof. Furthermore, while the tillage implement 10 is a vertical tillage implement in the illustrated embodiment, in other embodiments, the tillage implement may be a primary tillage implement or another suitable type of tillage implement.

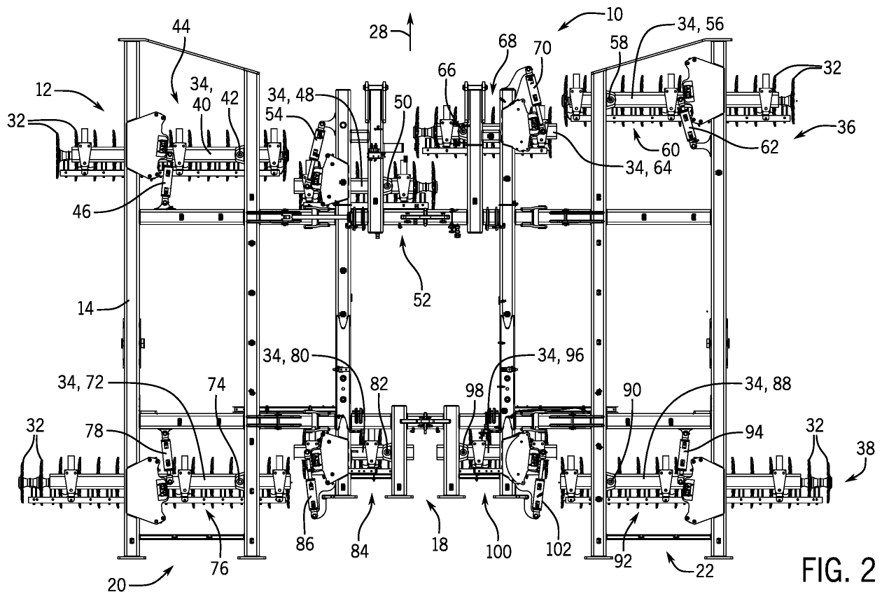

FIG. 2 is a top view of a portion of the tillage implement 10 of FIG. 1. As previously discussed, the disc blades 32 are arranged in two rows. As illustrated, the two rows include a front row 36 of disc blades 32 and a rear row 38 of disc blades 32, in which the front row 36 is positioned forward of the rear row 38 relative to the direction of travel 28. Furthermore, in the illustrated embodiment, the front row 36 includes four gangs of disc blades 32, and the rear row 38 includes four gangs of disc blades 32. As previously discussed, each gang of disc blades 32 is supported by a respective disc blade support 34.

In the illustrated embodiment, a front left wing disc blade support 40 (e.g., first disc blade support) is pivotally coupled to the left wing section 20 of the frame 14 at a front left wing pivot point 42 (e.g., first pivot point). The front left wing disc blade support 40 is configured to support a front left wing set 44 (e.g., first set) of disc blades 32. Furthermore, the disc blade adjustment system 12 includes a front left wing actuator 46 (e.g., first actuator) coupled (e.g., pivotally coupled) to the left wing section 20 of the frame 14 and to the front left wing disc blade support 40. The front left wing actuator 46 includes a cylinder, a piston disposed within the cylinder, and a single rod extending from the piston. As discussed in detail below, the front left wing actuator 46 is configured to drive the front left wing disc blade support 40 to pivot relative to the left wing section 20 of the frame 14 to control an angle (e.g., first angle) between the front left wing set 44 of disc blades 32 and the direction of travel 28 of the tillage implement 10.

In addition, a front left center disc blade support 48 (e.g., second disc blade support) is pivotally coupled to the center section 18 of the frame 14 at a front left center pivot point 50 (e.g., second pivot point). The front left center disc blade support 48 is configured to support a front left center set 52 (e.g., second set) of disc blades 32. Furthermore, the disc blade adjustment system 12 includes a front left center actuator 54 (e.g., second actuator) coupled (e.g., pivotally coupled) to the center section 18 of the frame 14 and to the front left center disc blade support 48. The front left center actuator 54 includes a cylinder, a piston disposed within the cylinder, and a single rod extending from the piston. As discussed in detail below, the front left center actuator 54 is configured to drive the front left center disc blade support 48 to pivot relative to the center section 18 of the frame 14 to control an angle (e.g., second angle) between the front left center set 52 of disc blades 32 and the direction of travel 28 of the tillage implement 10.

Furthermore, a front right wing disc blade support 56 (e.g., third disc blade support) is pivotally coupled to the right wing section 22 of the frame 14 at a front right wing pivot point 58 (e.g., third pivot point). The front right wing disc blade support 56 is configured to support a front right wing set 60 (e.g., third set) of disc blades 32. Furthermore, the disc blade adjustment system 12 includes a front right wing actuator 62 (e.g., third actuator) coupled (e.g., pivotally coupled) to the right wing section 22 of the frame 14 and to the front right wing disc blade support 56. The front right wing actuator 62 includes a cylinder, a piston disposed within the cylinder, and a single rod extending from the piston. As discussed in detail below, the front right wing actuator 62 is configured to drive the front right wing disc blade support 56 to pivot relative to the right wing section 22 of the frame 14 to control an angle (e.g., third angle) between the front right wing set 60 of disc blades 32 and the direction of travel 28 of the tillage implement 10.

In addition, a front right center disc blade support 64 (e.g., fourth disc blade support) is pivotally coupled to the center section 18 of the frame 14 at a front right center pivot point 66 (e.g., fourth pivot point). The front right center disc blade support 64 is configured to support a front right center set 68 (e.g., fourth set) of disc blades 32. Furthermore, the disc blade adjustment system 12 includes a front right center actuator 70 (e.g., fourth actuator) coupled (e.g., pivotally coupled) to the center section 18 of the frame 14 and to the front right center disc blade support 64. The front right center actuator 70 includes a cylinder, a piston disposed within the cylinder, and a single rod extending from the piston. As discussed in detail below, the front right center actuator 70 is configured to drive the front right center disc blade support 64 to pivot relative to the center section 18 of the frame 14 to control an angle (e.g., fourth angle) between the front right center set 68 of disc blades 32 and the direction of travel 28 of the tillage implement 10.

In the illustrated embodiment, a rear left wing disc blade support 72 (e.g., first disc blade support, third disc blade support) is pivotally coupled to the left wing section 20 of the frame 14 at a rear left wing pivot point 74 (e.g., first pivot point, third pivot point). The rear left wing disc blade support 72 is configured to support a rear left wing set 76 (e.g., first set, third set) of disc blades 32. Furthermore, the disc blade adjustment system 12 includes a rear left wing actuator 78 (e.g., first actuator, third actuator) coupled (e.g., pivotally coupled) to the left wing section 20 of the frame 14 and to the rear left wing disc blade support 72. The rear left wing actuator 78 includes a cylinder, a piston disposed within the cylinder, and a single rod extending from the piston. As discussed in detail below, the rear left wing actuator 78 is configured to drive the rear left wing disc blade support 72 to pivot relative to the left wing section 20 of the frame 14 to control an angle (e.g., first angle, third angle) between the rear left wing set 76 of disc blades 32 and the direction of travel 28 of the tillage implement 10.

In addition, a rear left center disc blade support 80 (e.g., second disc blade support, fourth disc blade support) is pivotally coupled to the center section 18 of the frame 14 at a rear left center pivot point 82 (e.g., second pivot point, fourth pivot point). The rear left center disc blade support 80 is configured to support a rear left center set 84 (e.g., second set, fourth set) of disc blades 32. Furthermore, the disc blade adjustment system 12 includes a rear left center actuator 86 (e.g., second actuator, fourth actuator) coupled (e.g., pivotally coupled) to the center section 18 of the frame 14 and to the rear left center disc blade support 80. The rear left center actuator 86 includes a cylinder, a piston disposed within the cylinder, and a single rod extending from the piston. As discussed in detail below, the rear left center actuator 86 is configured to drive the rear left center disc blade support 80 to pivot relative to the center section 18 of the frame 14 to control an angle (e.g., second angle, fourth angle) between the rear left center set 84 of disc blades 32 and the direction of travel 28 of the tillage implement 10.

Furthermore, a rear right wing disc blade support 88 (e.g., third disc blade support) is pivotally coupled to the right wing section 22 of the frame 14 at a rear right wing pivot point 90 (e.g., third pivot point). The rear right wing disc blade support 88 is configured to support a rear right wing set 92 (e.g., third set) of disc blades 32. Furthermore, the disc blade adjustment system 12 includes a rear right wing actuator 94 (e.g., third actuator) coupled (e.g., pivotally coupled) to the right wing section 22 of the frame 14 and to the rear right wing disc blade support 88. The rear right wing actuator 94 includes a cylinder, a piston disposed within the cylinder, and a single rod extending from the piston. As discussed in detail below, the rear right wing actuator 94 is configured to drive the rear right wing disc blade support 88 to pivot relative to the right wing section 22 of the frame 14 to control an angle (e.g., third angle) between the rear right wing set 92 of disc blades 32 and the direction of travel 28 of the tillage implement 10.

In addition, a rear right center disc blade support 96 (e.g., fourth disc blade support) is pivotally coupled to the center section 18 of the frame 14 at a rear right center pivot point 98 (e.g., fourth pivot point). The rear right center disc blade support 96 is configured to support a rear right center set 100 (e.g., fourth set) of disc blades 32. Furthermore, the disc blade adjustment system 12 includes a rear right center actuator 102 (e.g., fourth actuator) coupled (e.g., pivotally coupled) to the center section 18 of the frame 14 and to the rear right center disc blade support 96. The rear right center actuator 102 includes a cylinder, a piston disposed within the cylinder, and a single rod extending from the piston. As discussed in detail below, the rear right center actuator 102 is configured to drive the rear right center disc blade support 96 to pivot relative to the center section 18 of the frame 14 to control an angle (e.g., fourth angle) between the rear right center set 100 of disc blades 32 and the direction of travel 28 of the tillage implement 10.

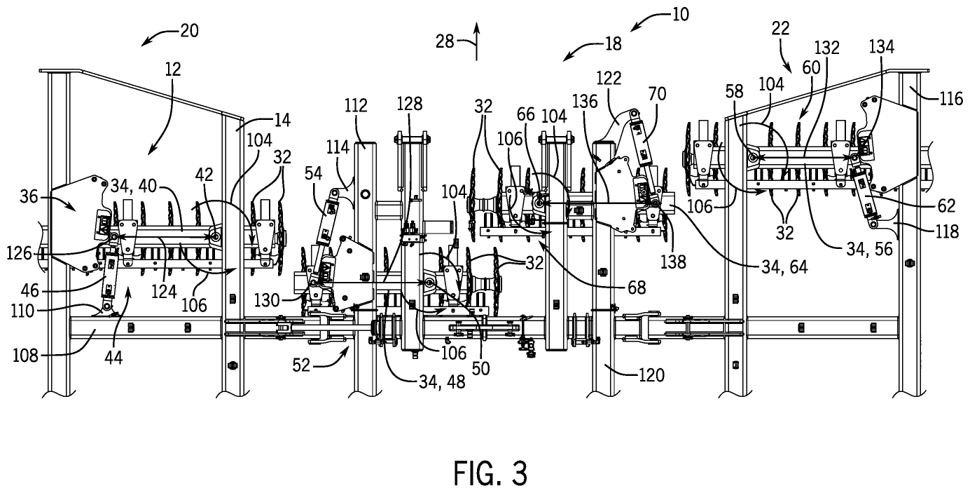

FIG. 3 is a top view of a front portion of the tillage implement 10 of FIG. 1. As previously discussed, the front left wing actuator 46 (e.g., first actuator) is configured to drive the front left wing disc blade support 40 (e.g., first disc blade support) to pivot relative to the left wing section 20 of the frame 14 to control an angle (e.g., first angle) between the front left wing set 44 of disc blades 32 and the direction of travel 28 of the tillage implement 10. In the illustrated embodiment, the front left wing actuator 46 is configured to drive the front left wing disc blade support 40 to pivot in a clockwise direction 104 (e.g., first direction) about the front left wing pivot point 42 (e.g., first pivot point) in response to extension of the rod of the front left wing actuator 46, and the front left wing actuator 46 is configured to drive the front left wing disc blade support 40 to pivot in a counter-clockwise direction 106 (e.g., second direction), which is opposite the clockwise direction 104, about the front left wing pivot point 42 in response to retraction of the rod of the front left wing actuator 46.

In the illustrated embodiment, the front left wing actuator 46 is coupled (e.g., pivotally coupled) to a lateral member 108 of the left wing section 20 of the frame 14 via a respective mount 110 (e.g., first mount). In addition, the front left wing actuator 46 is positioned behind the front left wing disc blade support 40 along the direction of travel 28, and the front left wing actuator/front left wing disc blade support attachment point is positioned outward from the front left wing pivot point 42 along a direction crosswise to the direction of travel 28. Accordingly, extension of the rod of the front left wing actuator 46 drives the front left wing disc blade support 40 to pivot in the clockwise direction 104, and retraction of the rod of the front left wing actuator 46 drives the front left wing disc blade support 40 to pivot in the counter-clockwise direction 106. In certain embodiments, the front left wing actuator 46 is oriented substantially tangent to an arc swept by the actuator/disc blade support attachment point as the front left wing disc blade support 40 pivots. However, in other embodiments, the front left wing actuator may be oriented at another suitable angle. Furthermore, in the illustrated embodiment, the rod of the front left wing □□□□□□□□□□□is coupled to the front left wing disc blade support 40, and the cylinder of the front left wing actuator 46 is coupled to the lateral member 108 of the left wing section 20 of the frame 14. However, in other embodiments, the rod of the front left wing actuator may be coupled to the lateral member of the left wing section of the frame, and the cylinder of the front left wing actuator may be coupled to the front left wing disc blade support. In addition, while the front left wing actuator 46 is positioned behind the front left wing disc blade support 40 along the direction of travel 28 and the actuator/disc blade support attachment point is positioned outward from (e.g., on the left side of) the front left wing pivot point 42 along the direction crosswise to the direction of travel 28 in the illustrated embodiment, in certain embodiments, the front left wing actuator may be positioned in front of the front left wing disc blade support along the direction of travel and the actuator/disc blade support attachment point may be positioned inward from (e.g., on the right side of) the front left wing pivot point along the direction crosswise to the direction of travel.

As previously discussed, the front left center actuator 54 (e.g., second actuator) is configured to drive the front left center disc blade support 48 (e.g., second disc blade support) to pivot relative to the center section 18 of the frame 14 to control an angle (e.g., second angle) between the front left center wing set 52 of disc blades 32 and the direction of travel 28 of the tillage implement 10. In the illustrated embodiment, the front left center actuator 54 is configured to drive the front left center disc blade support 48 to pivot in the clockwise direction 104 (e.g., first direction) about the front left center pivot point 50 (e.g., second pivot point) in response to retraction of the rod of the front left center actuator 54, and the front left center actuator 54 is configured to drive the front left center disc blade support 48 to pivot in the counter-clockwise direction 106 (e.g., second direction), which is opposite the clockwise direction 104, about the front left center pivot point 50 in response to extension of the rod of the front left center actuator 54.

In the illustrated embodiment, the front left center actuator 54 is coupled (e.g., pivotally coupled) to a longitudinal member 112 of the center section 18 of the frame 14 via a respective mount 114 (e.g., second mount). In addition, the front left center actuator 54 is positioned in front of the front left center disc blade support 48 along the direction of travel 28, and the front left center actuator/front left center disc blade support attachment point is positioned outward from the front left center pivot point 50 along the direction crosswise to the direction of travel 28. Accordingly, retraction of the rod of the front left center actuator 54 drives the front left center disc blade support 48 to pivot in the clockwise direction 104, and extension of the rod of the front left center actuator 54 drives the front left center disc blade support 48 to pivot in the counter-clockwise direction 106. In certain embodiments, the front left center actuator 54 is oriented substantially tangent to an arc swept by the actuator/disc blade support attachment point as the front left center disc blade support 48 pivots. However, in other embodiments, the front left center actuator may be oriented at another suitable angle. Furthermore, in the illustrated embodiment, the rod of the front left center actuator 54 is coupled to the front left center disc blade support 48, and the cylinder of the front left center actuator 54 is coupled to the longitudinal member 112 of the center section 18 of the frame 14. However, in other embodiments, the rod of the front left center actuator may be coupled to the longitudinal member of the center section of the frame, and the cylinder of the front left center actuator may be coupled to the front left center disc blade support. In addition, while the front left center actuator 54 is positioned in front of the front left center disc blade support 48 along the direction of travel 28 and the actuator/disc blade support attachment point is positioned outward from (e.g., on the left side of) the front left center pivot point 50 along the direction crosswise to the direction of travel 28 in the illustrated embodiment, in certain embodiments, the front left center actuator may be positioned behind the front left center disc blade support along the direction of travel and the actuator/disc blade support attachment point may be positioned inward from (e.g., on the right side of) the front left center pivot point along the direction crosswise to the direction of travel.

As previously discussed, the front right wing actuator 62 (e.g., third actuator) is configured to drive the front right wing disc blade support 56 (e.g., third disc blade support) to pivot relative to the right wing section 22 of the frame 14 to control an angle (e.g., third angle) between the front right wing set 60 of disc blades 32 and the direction of travel 28 of the tillage implement 10. In the illustrated embodiment, the front right wing actuator 62 is configured to drive the front right wing disc blade support 56 to pivot in the counter-clockwise direction 106 (e.g., second direction) about the front right wing pivot point 58 (e.g., third pivot point) in response to extension of the rod of the front right wing actuator 62, and the front right wing actuator 62 is configured to drive the front right wing disc blade support 56 to pivot in the clockwise direction 104 (e.g., first direction), which is opposite the counter-clockwise direction 106, about the front right wing pivot point 58 in response to retraction of the rod of the front right wing actuator 62.

In the illustrated embodiment, the front right wing actuator 62 is coupled (e.g., pivotally coupled) to a longitudinal member 116 of the right wing section 22 of the frame 14 via a respective mount 118 (e.g., first mount). In addition, the front right wing actuator 62 is positioned behind the front right wing disc blade support 56 along the direction of travel 28, and the front right wing actuator/front right wing disc blade support attachment point is positioned outward from the front right wing pivot point 58 along the direction crosswise to the direction of travel 28. Accordingly, extension of the rod of the front right wing actuator 62 drives the front right wing disc blade support 56 to pivot in the counter-clockwise direction 106, and retraction of the rod of the front right wing actuator 62 drives the front right wing disc blade support 56 to pivot in the clockwise direction 104. In certain embodiments, the front right wing actuator 62 is oriented substantially tangent to an arc swept by the actuator/disc blade support attachment point as the front right wing disc blade support 56 pivots. However, in other embodiments, the front right wing actuator may be oriented at another suitable angle. Furthermore, in the illustrated embodiment, the rod of the front right wing actuator 62 is coupled to the front right wing disc blade support 56, and the cylinder of the front right wing actuator 62 is coupled to the longitudinal member 116 of the right wing section 22 of the frame 14. However, in other embodiments, the rod of the front right wing actuator may be coupled to the longitudinal member of the right wing section of the frame, and the cylinder of the front right wing actuator may be coupled to the front right wing disc blade support. In addition, while the front right wing actuator 62 is positioned behind the front right wing disc blade support 56 along the direction of travel 28 and the actuator/disc blade support attachment point is positioned outward from (e.g., on the right side of) the front right wing pivot point 58 along the direction crosswise to the direction of travel 28 in the illustrated embodiment, in certain embodiments, the front right wing actuator may be positioned in front of the front right wing disc blade support along the direction of travel and the actuator/disc blade support attachment point may be positioned inward from (e.g., on the left side of) the front right wing pivot point along the direction crosswise to the direction of travel.

As previously discussed, the front right center actuator 70 (e.g., fourth actuator) is configured to drive the front right center disc blade support 64 (e.g., fourth disc blade support) to pivot relative to the center section 18 of the frame 14 to control an angle (e.g., fourth angle) between the front right center wing set 68 of disc blades 32 and the direction of travel 28 of the tillage implement 10. In the illustrated embodiment, the front right center actuator 70 is configured to drive the front right center disc blade support 64 to pivot in the counter-clockwise direction 106 (e.g., second direction) about the front right center pivot point 66 (e.g., fourth pivot point) in response to retraction of the rod of the front right center actuator 70, and the front right center actuator 70 is configured to drive the front right center disc blade support 64 to pivot in the clockwise direction 104 (e.g., first direction), which is opposite the counter-clockwise direction 106, about the front right center pivot point 66 in response to extension of the rod of the front right center actuator 70.

In the illustrated embodiment, the front right center actuator 70 is coupled (e.g., pivotally coupled) to a longitudinal member 120 of the center section 18 of the frame 14 via a respective mount 122 (e.g., second mount). The mount 122 positions a longitudinal end of the front right center actuator 70 longitudinally outward from (e.g., forward of) a longitudinal end of the longitudinal member 120. In addition, the front right center actuator 70 is positioned in front of the front right center disc blade support 64 along the direction of travel 28, and the front right center actuator/front right center disc blade support attachment point is positioned outward from the front right center pivot point 66 along the direction crosswise to the direction of travel 28. Accordingly, retraction of the rod of the front right center actuator 70 drives the front right center disc blade support 64 to pivot in the counter-clockwise direction 106, and extension of the rod of the front right center actuator 70 drives the front right center disc blade support 64 to pivot in the clockwise direction 104. The locations of the mounts for the front center actuators enables the front center actuators to be positioned in front of the respective disc blade supports and enables the respective sets of disc blades to be offset along the direction of travel, thereby enabling the respective sets of disc blades to overlap along the direction crosswise to the direction of travel. In certain embodiments, the front right center actuator 70 is oriented substantially tangent to an arc swept by the actuator/disc blade support attachment point as the front right center disc blade support 64 pivots. However, in other embodiments, the front right center actuator may be oriented at another suitable angle. Furthermore, in the illustrated embodiment, the rod of the front right center actuator 70 is coupled to the front right center disc blade support 64, and the cylinder of the front right center actuator 70 is coupled to the longitudinal member 120 of the center section 18 of the frame 14. However, in other embodiments, the rod of the front right center actuator may be coupled to the longitudinal member of the center section of the frame, and the cylinder of the front right center actuator may be coupled to the front right center disc blade support. In addition, while the front right center actuator 70 is positioned in front of the front right center disc blade support 64 along the direction of travel 28 and the actuator/disc blade support attachment point is positioned outward from (e.g., on the right side of) the front right center pivot point 66 along the direction crosswise to the direction of travel 28 in the illustrated embodiment, in certain embodiments, the front right center actuator may be positioned behind the front right center disc blade support along the direction of travel and the actuator/disc blade support attachment point may be positioned inward from (e.g., on the left side of) the front right center pivot point along the direction crosswise to the direction of travel.

As discussed in detail below, a conduit (e.g., first conduit) extends between a rod end of the front left wing actuator 46 and a rod end of the front left center actuator 54. The conduit is configured to enable fluid flow between the front left wing actuator 46 and the front left center actuator 54. In addition, a conduit (e.g., second conduit) extends between a cap end of the front left center actuator 54 and a cap end of the front right wing actuator 62. The conduit is configured to enable fluid flow between the front left center actuator 54 and the front right wing actuator 62. Furthermore, a conduit (e.g., third conduit) extends between a rod end of the front right wing actuator 62 and a rod end of the front right center actuator 70. The conduit is configured to enable fluid flow between the front right wing actuator 62 and the front right center actuator 70. Accordingly, providing fluid to the cap end of the front left wing actuator 46 drives the respective rod to extend, thereby driving the front left wing disc blade support 40 to pivot in the clockwise direction 104 and driving fluid to move from the rod end of the front left wing actuator 46 to the rod end of the front left center actuator 54. As fluid flows to the rod end of the front left center actuator 54, the respective rod is driven to retract, thereby driving the front left center disc blade support 48 to pivot in the clockwise direction 104 and driving fluid to move from the cap end of the front left center actuator 54 to the cap end of the front right wing actuator 62. As fluid flows to the cap end of the front right wing actuator 62, the respective rod is driven to extend, thereby driving the front right wing disc blade support 56 to pivot in the counter-clockwise direction 106 and driving fluid to move from the rod end of the front right wing actuator 62 to the rod end of the front right center actuator 70. As fluid flows to the rod end of the front right center actuator 70, the respective rod is driven to retract, thereby driving the front right center disc blade support 64 to pivot in the counter-clockwise direction 106. As a result, each front disc blade support is driven to pivot by providing fluid to the cap end of the front left wing actuator 46.

In the illustrated embodiment, a cross-sectional area (e.g., diameter, etc.) of the rod of the front left wing actuator 46, a cross-sectional area (e.g., diameter, etc.) of the rod of the front left center actuator 54, a cross-sectional area (e.g., diameter, etc.) of the rod of the front right wing actuator 62, and a cross-sectional area (e.g., diameter, etc.) of the rod of the front right center actuator 70 are substantially equal to one another. In addition, an internal cross-sectional area (e.g., bore diameter, etc.) of the cylinder of the front left wing actuator 46, an internal cross-sectional area (e.g., bore diameter, etc.) of the cylinder of the front left center actuator 54, an internal cross-sectional area (e.g., bore diameter, etc.) of the cylinder of the front right wing actuator 62, and an internal cross-sectional area (e.g., bore diameter, etc.) of the cylinder of the front right center actuator 70 are substantially equal to one another. Accordingly, due to the cap end to cap end/rod end to rod end connections between the actuators, as fluid is provided to the cap end of the front left wing actuator 46, the rods of the front actuators extend/retract substantially equal distances. As used herein, “substantially equal” refers to values that are within 5 percent, 4 percent, 3 percent, 2 percent, 1 percent, 0.5 percent, or 0.1 percent of one another. In certain embodiments, a stroke length (e.g., internal cylinder length) of the front left wing actuator 46, a stroke length (e.g., internal cylinder length) of the front left center actuator 54, a stroke length (e.g., internal cylinder length) of the front right wing actuator 62, and a stroke length (e.g., internal cylinder length) of the front right center actuator 70 are substantially equal to one another. Accordingly, providing fluid to the cap end of the front left wing actuator 46 until the respective rod is fully extended causes the rod of the front left center actuator 54 to fully retract, the rod of the front right wing actuator 62 to fully extend, and the rod of the front right center actuator 70 to fully retract. While front actuators having equal stroke lengths is disclosed above, in certain embodiments, at least one actuator may have a different stroke length than at least one other actuator. Furthermore, in certain embodiments, the front left wing actuator 46, the front left center actuator 54, the front right wing actuator 62, and the front right center actuator 70 are substantially identical to one another. As a result, the cost and/or complexity of the disc blade angle adjustment system may be reduced (e.g., as compared to a disc blade angle adjustment system having multiple types of front actuators). As used herein with regard to the actuators, “substantially identical” refers to actuators that are within manufacturing tolerances of one another (e.g., the actuators have the same part number, etc.).

In the illustrated embodiment, an offset distance 124 between the front left wing pivot point 42 and the front left wing actuator/front left wing disc blade support attachment point 126, an offset distance 128 between the front left center pivot point 50 and the front left center actuator/front left center disc blade support attachment point 130, an offset distance 132 between the front right wing pivot point 58 and the front right wing actuator/front right wing disc blade support attachment point 134, and an offset distance 136 between the front right center pivot point 66 and the front right center actuator/front right center disc blade support attachment point 138 are substantially equal to one another. Because providing fluid to the cap end of the front left wing actuator causes the rods of the front actuators to extend/retract substantially equal distances, and because the offset distances between the front pivot points and front actuator/front disc blade support attachment points are substantially equal to one another, the angles of the sets of disc blades relative to the direction of travel vary substantially equally (e.g., within 5 percent, 4 percent, 3 percent, 2 percent, 1 percent, 0.5 percent, or 0.1 percent of one another) in response to providing fluid to the cap end of the front left wing actuator. Accordingly, the angles of the sets of disc blades relative to the direction of travel may be set to substantially equal values by providing fluid to the cap end of the front left wing actuator. While the rod cross-sectional areas of the actuators are substantially equal to one another, the cylinder internal cross-sectional areas of the actuators are substantially equal to one another, and the offset distances are substantially equal to one another in the illustrated embodiment, in other embodiments, the rod cross-sectional area and/or the cylinder internal cross-sectional area of at least one actuator may be different than the rod cross-sectional area and/or the cylinder internal cross-sectional area of at least one other actuator, and/or the offset distance for at least one actuator may be different than the offset distance for at least one other actuator. For example, in certain embodiments, the rod cross-sectional area and/or the cylinder internal cross-sectional area of a first actuator may be different than the rod cross-sectional area and/or the cylinder internal cross-sectional area of a second actuator. However, the offset distances for the first and second actuators may be selected such that the actuators drive the respective disc blade supports to pivot through substantially equal angles in response to extension/retraction of the rods. In certain embodiments, the stroke lengths of the first and second actuators may be selected such that the volume within the respective cylinders is substantially equal, even though the rod cross-sectional areas and/or the cylinder internal cross-sectional areas are different. In such embodiments, providing fluid to the cap end of one actuator until the respective rod is fully extended causes the rod of the other actuator to fully retract.

In the illustrated embodiment, the disc blade supports 34 are pivotally coupled to the frame 14 at locations that enable the respective sets of disc blades to pivot through angular ranges of motion (e.g., established by the stroke lengths of the respective actuators) without interfering with one another. For example, the disc blade supports 34 may be offset from one another along the direction of travel 28. Each actuator may be coupled to the frame at a location based on the position of the respective disc blade support, the respective offset distance, the respective pivot direction/rod movement direction relationship (e.g., extension of the rod drives the disc blade support to pivot in the clockwise direction, etc.), or a combination thereof. While the actuators are coupled to the frame at the locations disclosed above in the illustrated embodiment, in other embodiments, at least one actuator may be coupled to the frame at a different suitable location (e.g., based on the position of the respective disc blade support, the respective offset distance, the respective pivot direction/rod movement direction relationship, or a combination thereof).

While certain actuators are configured to drive the respective disc blade supports to pivot in the clockwise direction in response to extension of the respective rods and to drive the respective disc blade supports to pivot in the counter-clockwise direction in response to retraction of the respective rods, in certain embodiments, at least one such actuator may be configured to drive the respective disc blade support to pivot in the counter-clockwise direction in response to extension of the respective rod and to drive the respective disc blade support to pivot in the clockwise direction in response to retraction of the respective rod. For example, the actuator/disc blade support attachment point may be positioned on the opposite side of the respective pivot point along the direction crosswise to the direction of travel, or the actuator may be positioned on the opposite side of the respective disc blade support along the direction of travel. Furthermore, while certain actuators are configured to drive the respective disc blade supports to pivot in the counter-clockwise direction in response to extension of the respective rods and to drive the respective disc blade supports to pivot in the clockwise direction in response to retraction of the respective rods, in certain embodiments, at least one such actuator may be configured to drive the respective disc blade support to pivot in the clockwise direction in response to extension of the respective rod and to drive the respective disc blade support to pivot in the counter-clockwise direction in response to retraction of the respective rod. For example, the actuator/disc blade support attachment point may be positioned on the opposite side of the respective pivot point along the direction crosswise to the direction of travel, or the actuator may be positioned on the opposite side of the respective disc blade support along the direction of travel.

While the front row 36 of disc blades 32 is formed by four disc blade supports 34 and four actuators drive the four disc blade supports 34 to pivot in the illustrated embodiment, in other embodiments, the front row may be formed by more or fewer disc blade supports and/or more or fewer actuators may drive the disc blade support(s) to pivot. For example, in certain embodiments, the front row may be formed by two disc blade supports, and two actuators may drive the disc blade supports to pivot, or the front row may be formed by six disc blade supports, and six actuators may drive the disc blade supports to pivot. In such embodiments, the actuators may be fluidly coupled to one another in the manner disclosed above (e.g., cap end to cap end/rod end to rod end), and the actuators may be positioned to drive the disc blade supports to pivot in the manner disclosed above (e.g., at least two disc blade supports may be driven to pivot in the same direction via extension of the rod of one actuator and retraction of the rod of another actuator, in which the actuators are fluidly coupled to one another). Furthermore, while each disc blade support is driven to pivot by a respective actuator in the illustrated embodiment, in other embodiments, at least two disc blade supports may be coupled to one another by a linkage, and one actuator (e.g., coupled to one disc blade support or the linkage) may be configured to drive the disc blade supports to pivot.

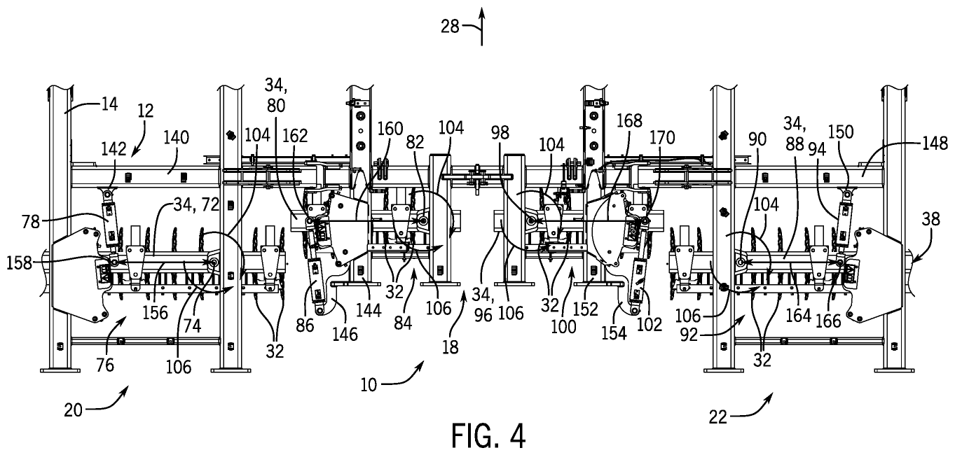

FIG. 4 is a top view of a rear portion of the tillage implement 10 of FIG. 1. As previously discussed, the rear left wing actuator 78 (e.g., first actuator, third actuator) is configured to drive the rear left wing disc blade support 72 (e.g., first disc blade support, third disc blade support) to pivot relative to the left wing section 20 of the frame 14 to control an angle (e.g., first angle, third angle) between the rear left wing set 76 of disc blades 32 and the direction of travel 28 of the tillage implement 10. In the illustrated embodiment, the rear left wing actuator 78 is configured to drive the rear left wing disc blade support 72 to pivot in the counter-clockwise direction 106 (e.g., second direction) about the rear left wing pivot point 74 (e.g., first pivot point, third pivot point) in response to extension of the rod of the rear left wing actuator 78, and the rear left wing actuator 78 is configured to drive the rear left wing disc blade support 72 to pivot in the clockwise direction 104 (e.g., first direction), which is opposite the counter-clockwise direction 106, about the rear left wing pivot point 74 in response to retraction of the rod of the rear left wing actuator 78.

In the illustrated embodiment, the rear left wing actuator 78 is coupled (e.g., pivotally coupled) to a lateral member 140 of the left wing section 20 of the frame 14 via a respective mount 142 (e.g., first mount). In addition, the rear left wing actuator 78 is positioned in front of the rear left wing disc blade support 72 along the direction of travel 28, and the rear left wing actuator/rear left wing disc blade support attachment point is positioned outward from the rear left wing pivot point 74 along the direction crosswise to the direction of travel 28. Accordingly, extension of the rod of the rear left wing actuator 78 drives the rear left wing disc blade support 72 to pivot in the counter-clockwise direction 106, and retraction of the rod of the rear left wing actuator 78 drives the rear left wing disc blade support 72 to pivot in the clockwise direction 104. In certain embodiments, the rear left wing actuator 78 is oriented substantially tangent to an arc swept by the actuator/disc blade support attachment point as the rear left wing disc blade support 72 pivots. However, in other embodiments, the rear left wing actuator may be oriented at another suitable angle. Furthermore, in the illustrated embodiment, the rod of the rear left wing actuator 78 is coupled to the rear left wing disc blade support 72, and the cylinder of the rear left wing actuator 78 is coupled to the lateral member 140 of the left wing section 20 of the frame 14. However, in other embodiments, the rod of the rear left wing actuator may be coupled to the lateral member of the left wing section of the frame, and the cylinder of the rear left wing actuator may be coupled to the rear left wing disc blade support. In addition, while the rear left wing actuator 78 is positioned in front of the rear left wing disc blade support 72 along the direction of travel 28 and the actuator/disc blade support attachment point is positioned outward from (e.g., on the left side of) the rear left wing pivot point 74 along the direction crosswise to the direction of travel 28 in the illustrated embodiment, in certain embodiments, the rear left wing actuator may be positioned behind the rear left wing disc blade support along the direction of travel and the actuator/disc blade support attachment point may be positioned inward from (e.g., on the right side of) the rear left wing pivot point along the direction crosswise to the direction of travel.

As previously discussed, the rear left center actuator 86 (e.g., second actuator, fourth actuator) is configured to drive the rear left center disc blade support 80 (e.g., second disc blade support, fourth disc blade support) to pivot relative to the center section 18 of the frame 14 to control an angle (e.g., second angle, fourth angle) between the rear left center wing set 84 of disc blades 32 and the direction of travel 28 of the tillage implement 10. In the illustrated embodiment, the rear left center actuator 86 is configured to drive the rear left center disc blade support 80 to pivot in the counter-clockwise direction 106 (e.g., second direction) about the rear left center pivot point 82 (e.g., second pivot point, fourth pivot point) in response to retraction of the rod of the rear left center actuator 86, and the rear left center actuator 86 is configured to drive the rear left center disc blade support 80 to pivot in the clockwise direction 104 (e.g., first direction), which is opposite the counter-clockwise direction 106, about the rear left center pivot point 82 in response to extension of the rod of the rear left center actuator 86.

In the illustrated embodiment, the rear left center actuator 86 is coupled (e.g., pivotally coupled) to a longitudinal member 144 of the center section 18 of the frame 14 (e.g., which may correspond to the longitudinal member 112 disclosed above) via a respective mount 146 (e.g., second mount). The mount 146 positions a longitudinal end of the rear left center actuator 86 longitudinally outward from (e.g., behind) a longitudinal end of the longitudinal member 144. In addition, the rear left center actuator 86 is positioned behind the rear left center disc blade support 80 along the direction of travel 28, and the rear left center actuator/rear left center disc blade support attachment point is positioned outward from the rear left center pivot point 82 along the direction crosswise to the direction of travel 28. Accordingly, retraction of the rod of the rear left center actuator 86 drives the rear left center disc blade support 80 to pivot in the counter-clockwise direction 106, and extension of the rod of the rear left center actuator 86 drives the rear left center disc blade support 80 to pivot in the clockwise direction 104. In certain embodiments, the rear left center actuator 86 is oriented substantially tangent to an arc swept by the actuator/disc blade support attachment point as the rear left center disc blade support 80 pivots. However, in other embodiments, the rear left center actuator may be oriented at another suitable angle. Furthermore, in the illustrated embodiment, the rod of the rear left center actuator 86 is coupled to the rear left center disc blade support 80, and the cylinder of the rear left center actuator 86 is coupled to the longitudinal member 144 of the center section 18 of the frame 14. However, in other embodiments, the rod of the rear left center actuator may be coupled to the longitudinal member of the center section of the frame, and the cylinder of the rear left center actuator may be coupled to the rear left center disc blade support. In addition, while the rear left center actuator 86 is positioned behind the rear left center disc blade support 80 along the direction of travel 28 and the actuator/disc blade support attachment point is positioned outward from (e.g., on the left side of) the rear left center pivot point 82 along the direction crosswise to the direction of travel 28 in the illustrated embodiment, in certain embodiments, the rear left center actuator may be positioned in front of the rear left center disc blade support along the direction of travel and the actuator/disc blade support attachment point may be positioned inward from (e.g., on the right side of) the rear left center pivot point along the direction crosswise to the direction of travel.

As previously discussed, the rear right wing actuator 94 (e.g., third actuator) is configured to drive the rear right wing disc blade support 88 (e.g., third disc blade support) to pivot relative to the right wing section 22 of the frame 14 to control an angle (e.g., third angle) between the rear right wing set 92 of disc blades 32 and the direction of travel 28 of the tillage implement 10. In the illustrated embodiment, the rear right wing actuator 94 is configured to drive the rear right wing disc blade support 88 to pivot in the clockwise direction 104 (e.g., first direction) about the rear right wing pivot point 90 (e.g., third pivot point) in response to extension of the rod of the rear right wing actuator 94, and the rear right wing actuator 94 is configured to drive the rear right wing disc blade support 88 to pivot in the counter-clockwise direction 106 (e.g., second direction), which is opposite the clockwise direction 104, about the rear right wing pivot point 90 in response to retraction of the rod of the rear right wing actuator 94.

In the illustrated embodiment, the rear right wing actuator 94 is coupled (e.g., pivotally coupled) to a lateral member 148 of the right wing section 22 of the frame 14 via a respective mount 150 (e.g., first mount). In addition, the rear right wing actuator 94 is positioned in front of the rear right wing disc blade support 88 along the direction of travel 28, and the rear right wing actuator/rear right wing disc blade support attachment point is positioned outward from the rear right wing pivot point 90 along the direction crosswise to the direction of travel 28. Accordingly, extension of the rod of the rear right wing actuator 94 drives the rear right wing disc blade support 88 to pivot in the clockwise direction 104, and retraction of the rod of the rear right wing actuator 94 drives the rear right wing disc blade support 88 to pivot in the counter-clockwise direction 106. In certain embodiments, the rear right wing actuator 94 is oriented substantially tangent to an arc swept by the actuator/disc blade support attachment point as the rear right wing disc blade support 88 pivots. However, in other embodiments, the rear right wing actuator may be oriented at another suitable angle. Furthermore, in the illustrated embodiment, the rod of the rear right wing actuator 94 is coupled to the rear right wing disc blade support 88, and the cylinder of the rear right wing actuator 94 is coupled to the lateral member 148 of the right wing section 22 of the frame 14. However, in other embodiments, the rod of the rear right wing actuator may be coupled to the lateral member of the right wing section of the frame, and the cylinder of the rear right wing actuator may be coupled to the rear right wing disc blade support. In addition, while the rear right wing actuator 94 is positioned in front of the rear right wing disc blade support 88 along the direction of travel 28 and the actuator/disc blade support attachment point is positioned outward from (e.g., on the right side of) the rear right wing pivot point 90 along the direction crosswise to the direction of travel 28 in the illustrated embodiment, in certain embodiments, the rear right wing actuator may be positioned behind the rear right wing disc blade support along the direction of travel and the actuator/disc blade support attachment point may be positioned inward from (e.g., on the left side of) the rear right wing pivot point along the direction crosswise to the direction of travel.

As previously discussed, the rear right center actuator 102 (e.g., fourth actuator) is configured to drive the rear right center disc blade support 96 (e.g., fourth disc blade support) to pivot relative to the center section 18 of the frame 14 to control an angle (e.g., fourth angle) between the rear right center wing set 100 of disc blades 32 and the direction of travel 28 of the tillage implement 10. In the illustrated embodiment, the rear right center actuator 102 is configured to drive the rear right center disc blade support 96 to pivot in the clockwise direction 104 (e.g., first direction) about the rear right center pivot point 98 (e.g., fourth pivot point) in response to retraction of the rod of the rear right center actuator 102, and the rear right center actuator 102 is configured to drive the rear right center disc blade support 96 to pivot in the counter-clockwise direction 106 (e.g., second direction), which is opposite the clockwise direction 104, about the rear right center pivot point 98 in response to extension of the rod of the rear right center actuator 102.

In the illustrated embodiment, the rear right center actuator 102 is coupled (e.g., pivotally coupled) to a longitudinal member 152 of the center section 18 of the frame 14 (e.g., which may correspond to the longitudinal member 120 disclosed above) via a respective mount 154 (e.g., second mount). The mount 154 positions a longitudinal end of the rear right center actuator 102 longitudinally outward from (e.g., behind) a longitudinal end of the longitudinal member 152. In addition, the rear right center actuator 102 is positioned behind the rear right center disc blade support 96 along the direction of travel 28, and the rear right center actuator/rear right center disc blade support attachment point is positioned outward from the rear right center pivot point 98 along the direction crosswise to the direction of travel 28. Accordingly, retraction of the rod of the rear right center actuator 102 drives the rear right center disc blade support 96 to pivot in the clockwise direction 104, and extension of the rod of the rear right center actuator 102 drives the rear right center disc blade support 96 to pivot in the counter-clockwise direction 106. In certain embodiments, the rear right center actuator 102 is oriented substantially tangent to an arc swept by the actuator/disc blade support attachment point as the rear right center disc blade support 96 pivots. However, in other embodiments, the rear right center actuator may be oriented at another suitable angle. Furthermore, in the illustrated embodiment, the rod of the rear right center actuator 102 is coupled to the rear right center disc blade support 96, and the cylinder of the rear right center actuator 102 is coupled to the longitudinal member 152 of the center section 18 of the frame 14. However, in other embodiments, the rod of the rear right center actuator may be coupled to the longitudinal member of the center section of the frame, and the cylinder of the rear right center actuator may be coupled to the rear right center disc blade support. In addition, while the rear right center actuator 102 is positioned behind the rear right center disc blade support 96 along the direction of travel 28 and the actuator/disc blade support attachment point is positioned outward from (e.g., on the right side of) the rear right center pivot point 98 along the direction crosswise to the direction of travel 28 in the illustrated embodiment, in certain embodiments, the rear right center actuator may be positioned in front of the rear right center disc blade support along the direction of travel and the actuator/disc blade support attachment point may be positioned inward from (e.g., on the left side of) the rear right center pivot point along the direction crosswise to the direction of travel.

As discussed in detail below, a conduit (e.g., first conduit) extends between a rod end of the rear left wing actuator 78 and a rod end of the rear left center actuator 86. The conduit is configured to enable fluid flow between the rear left wing actuator 78 and the rear left center actuator 86. In addition, a conduit (e.g., second conduit) extends between a cap end of the rear left center actuator 86 and a cap end of the rear right wing actuator 94. The conduit is configured to enable fluid flow between the rear left center actuator 86 and the rear right wing actuator 94. Furthermore, a conduit (e.g., third conduit) extends between a rod end of the rear right wing actuator 94 and a rod end of the rear right center actuator 102. The conduit is configured to enable fluid flow between the rear right wing actuator 94 and the rear right center actuator 102. Accordingly, providing fluid to the cap end of the rear left wing actuator 78 drives the respective rod to extend, thereby driving the rear left wing disc blade support 72 to pivot in the counter-clockwise direction 106 and driving fluid to move from the rod end of the rear left wing actuator 78 to the rod end of the rear left center actuator 86. As fluid flows to the rod end of the rear left center actuator 86, the respective rod is driven to retract, thereby driving the rear left center disc blade support 80 to pivot in the counter-clockwise direction 106 and driving fluid to move from the cap end of the rear left center actuator 86 to the cap end of the rear right wing actuator 94. As fluid flows to the cap end of the rear right wing actuator 94, the respective rod is driven to extend, thereby driving the rear right wing disc blade support 88 to pivot in the clockwise direction 104 and driving fluid to move from the rod end of the rear right wing actuator 94 to the rod end of the rear right center actuator 102. As fluid flows to the rod end of the rear right center actuator 102, the respective rod is driven to retract, thereby driving the rear right center disc blade support 96 to pivot in the clockwise direction 104. As a result, each rear disc blade support is driven to pivot by providing fluid to the cap end of the rear left wing actuator 78.

In the illustrated embodiment, a cross-sectional area (e.g., diameter, etc.) of the rod of the rear left wing actuator 78, a cross-sectional area (e.g., diameter, etc.) of the rod of the rear left center actuator 86, a cross-sectional area (e.g., diameter, etc.) of the rod of the rear right wing actuator 94, and a cross-sectional area (e.g., diameter, etc.) of the rod of the rear right center actuator 102 are substantially equal to one another. In addition, an internal cross-sectional area (e.g., bore diameter, etc.) of the cylinder of the rear left wing actuator 78, an internal cross-sectional area (e.g., bore diameter, etc.) of the cylinder of the rear left center actuator 86, an internal cross-sectional area (e.g., bore diameter, etc.) of the cylinder of the rear right wing actuator 94, and an internal cross-sectional area (e.g., bore diameter, etc.) of the cylinder of the rear right center actuator 102 are substantially equal to one another. Accordingly, due to the cap end to cap end/rod end to rod end connections between the actuators, as fluid is provided to the cap end of the rear left wing actuator 78, the rods of the rear actuators extend/retract substantially equal distances. As used herein, “substantially equal” refers to values that are within 5 percent, 4 percent, 3 percent, 2 percent, 1 percent, 0.5 percent, or 0.1 percent of one another. In certain embodiments, a stroke length (e.g., internal cylinder length) of the rear left wing actuator 78, a stroke length (e.g., internal cylinder length) of the rear left center actuator 86, a stroke length (e.g., internal cylinder length) of the rear right wing actuator 94, and a stroke length (e.g., internal cylinder length) of the rear right center actuator 102 are substantially equal to one another. Accordingly, providing fluid to the cap end of the rear left wing actuator 78 until the respective rod is fully extended causes the rod of the rear left center actuator 86 to fully retract, the rod of the rear right wing actuator 94 to fully extend, and the rod of the rear right center actuator 102 to fully retract. While rear actuators having equal stroke lengths is disclosed above, in certain embodiments, at least one actuator may have a different stroke length than at least one other actuator. Furthermore, in certain embodiments, the rear left wing actuator 78, the rear left center actuator 86, the rear right wing actuator 94, and the rear right center actuator 102 are substantially identical to one another. As a result, the cost and/or complexity of the disc blade angle adjustment system may be reduced (e.g., as compared to a disc blade angle adjustment system having multiple types of rear actuators). Furthermore, in certain embodiments, the rear left wing actuator 78, the rear left center actuator 86, the rear right wing actuator 94, the rear right center actuator 102, the front left wing actuator, the front left center actuator, the front right wing actuator, and the front right center actuator are substantially identical to one another, thereby further reducing the cost and/or complexity of the disc blade angle adjustment system. As used herein with regard to the actuators, “substantially identical” refers to actuators that are within manufacturing tolerances of one another (e.g., the actuators have the same part number, etc.).

In the illustrated embodiment, an offset distance 156 between the rear left wing pivot point 74 and the rear left wing actuator/rear left wing disc blade support attachment point 158, an offset distance 160 between the rear left center pivot point 82 and the rear left center actuator/rear left center disc blade support attachment point 162, an offset distance 164 between the rear right wing pivot point 90 and the rear right wing actuator/rear right wing disc blade support attachment point 166, and an offset distance 168 between the rear right center pivot point 98 and the rear right center actuator/rear right center disc blade support attachment point 170 are substantially equal to one another. Because providing fluid to the cap end of the rear left wing actuator causes the rods of the rear actuators to extend/retract substantially equal distances, and because the offset distances between the rear pivot points and rear actuator/rear disc blade support attachment points are substantially equal to one another, the angles of the sets of disc blades relative to the direction of travel vary substantially equally (e.g., within 5 percent, 4 percent, 3 percent, 2 percent, 1 percent, 0.5 percent, or 0.1 percent of one another) in response to providing fluid to the cap end of the rear left wing actuator. Accordingly, the angles of the sets of disc blades relative to the direction of travel may be set to substantially equal values by providing fluid to the cap end of the rear left wing actuator. While the rod cross-sectional areas of the actuators are substantially equal to one another, the cylinder internal cross-sectional areas of the actuators are substantially equal to one another, and the offset distances are substantially equal to one another in the illustrated embodiment, in other embodiments, the rod cross-sectional area and/or the cylinder internal cross-sectional area of at least one actuator may be different than the rod cross-sectional area and/or the cylinder internal cross-sectional area of at least one other actuator, and/or the offset distance for at least one actuator may be different than the offset distance for at least one other actuator. For example, in certain embodiments, the rod cross-sectional area and/or the cylinder internal cross-sectional area of a first actuator may be different than the rod cross-sectional area and/or the cylinder internal cross-sectional area of a second actuator. However, the offset distances for the first and second actuators may be selected such that the actuators drive the respective disc blade supports to pivot through substantially equal angles in response to extension/retraction of the rods. Furthermore, in certain embodiments, the rod cross-sectional areas of the front and rear actuators are substantially equal to one another, the cylinder internal cross-sectional areas of the front and rear actuators are substantially equal to one another, and the offset distances for the front and rear rows are substantially equal to one another. Accordingly, the sets of disc blades of the front row and the sets of disc blades of the rear row may pivot through the same angle in response to receiving the same volume of fluid at the left wing actuator. Furthermore, in certain embodiments, the stroke lengths of the front and rear actuators may be substantially equal to one another (e.g., the front and rear actuators may be substantially identical).

In the illustrated embodiment, the disc blade supports 34 are pivotally coupled to the frame 14 at locations that enable the respective sets of disc blades to pivot through angular ranges of motion (e.g., established by the stroke lengths of the respective actuators) without interfering with one another. For example, the disc blade supports 34 may be offset from one another along the direction of travel 28. Each actuator may be coupled to the frame at a location based on the position of the respective disc blade support, the respective offset distance, the respective pivot direction/rod movement direction relationship (e.g., extension of the rod drives the disc blade support to pivot in the clockwise direction, etc.), or a combination thereof. While the actuators are coupled to the frame at the locations disclosed above in the illustrated embodiment, in other embodiments, at least one actuator may be coupled to the frame at a different suitable location (e.g., based on the position of the respective disc blade support, the respective offset distance, the respective pivot direction/rod movement direction relationship, or a combination thereof).

While certain actuators are configured to drive the respective disc blade supports to pivot in the clockwise direction in response to extension of the respective rods and to drive the respective disc blade supports to pivot in the counter-clockwise direction in response to retraction of the respective rods, in certain embodiments, at least one such actuator may be configured to drive the respective disc blade support to pivot in the counter-clockwise direction in response to extension of the respective rod and to drive the respective disc blade support to pivot in the clockwise direction in response to retraction of the respective rod. For example, the actuator/disc blade support attachment point may be positioned on the opposite side of the respective pivot point along the direction crosswise to the direction of travel, or the actuator may be positioned on the opposite side of the respective disc blade support along the direction of travel. Furthermore, while certain actuators are configured to drive the respective disc blade supports to pivot in the counter-clockwise direction in response to extension of the respective rods and to drive the respective disc blade supports to pivot in the clockwise direction in response to retraction of the respective rods, in certain embodiments, at least one such actuator may be configured to drive the respective disc blade support to pivot in the clockwise direction in response to extension of the respective rod and to drive the respective disc blade support to pivot in the counter-clockwise direction in response to retraction of the respective rod. For example, the actuator/disc blade support attachment point may be positioned on the opposite side of the respective pivot point along the direction crosswise to the direction of travel, or the actuator may be positioned on the opposite side of the respective disc blade support along the direction of travel.

While the rear row 38 of disc blades 32 is formed by four disc blade supports 34 and four actuators drive the four disc blade supports 34 to pivot in the illustrated embodiment, in other embodiments, the rear row may be formed by more or fewer disc blade supports and/or more or fewer actuators may drive the disc blade support(s) to pivot. For example, in certain embodiments, the rear row may be formed by two disc blade supports, and two actuators may drive the disc blade supports to pivot, or the rear row may be formed by six disc blade supports, and six actuators may drive the disc blade supports to pivot. In such embodiments, the actuators may be fluidly coupled to one another in the manner disclosed above (e.g., cap end to cap end/rod end to rod end), and the actuators may be positioned to drive the disc blade supports to pivot in the manner disclosed above (e.g., at least two disc blade supports may be driven to pivot in the same direction via extension of the rod of one actuator and retraction of the rod of another actuator, in which the actuators are fluidly coupled to one another). Furthermore, while each disc blade support is driven to pivot by a respective actuator in the illustrated embodiment, in other embodiments, at least two disc blade supports may be coupled to one another by a linkage, and one actuator (e.g., coupled to one disc blade support or the linkage) may be configured to drive the disc blade supports to pivot.

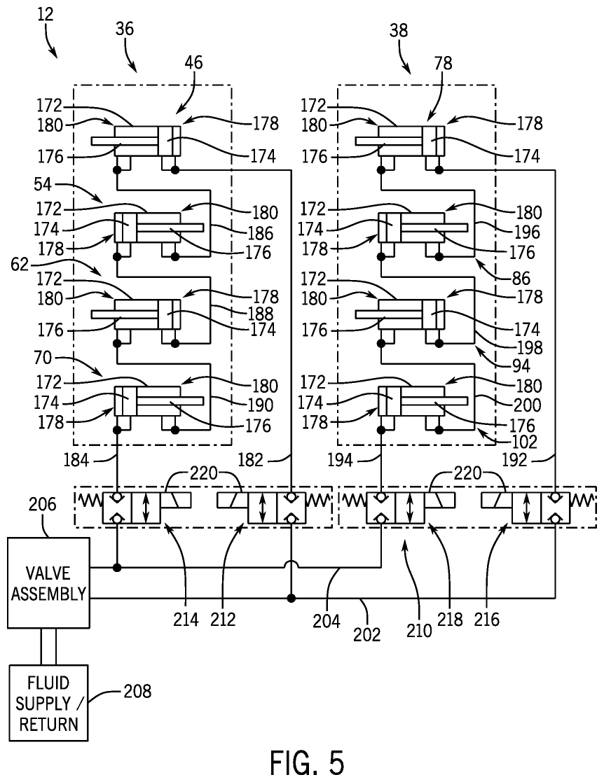

FIG. 5 is a schematic diagram of an embodiment of a disc blade angle adjustment system 12 that may be employed within the tillage implement of FIG. 1. As previously discussed, the disc blade angle adjustment system 12 includes front and rear actuators configured to control angles of respective sets of disc blades relative to the direction of travel of the tillage implement. As illustrated, each actuator includes a cylinder 172 and a piston 174 disposed within the cylinder 172. In addition, a single rod 176 extends from the piston. Providing fluid to the cap end 178 of the actuator drives the rod 176 to extend, and providing fluid to the rod end 180 of the actuator drives the rod 176 to retract. As used herein with regard to the actuators, “single rod” refers to a single rod extending from the piston in one direction, as compared to an actuator having a first rod extending in a first direction from the piston and a second rod extending in a second direction, opposite the first direction, from the piston. Furthermore, as used herein, “cylinder” refers to a body of the actuator that houses the piston. The cylinder does not necessarily have a cylindrical shape. For example, at least one actuator may have a cylinder with a polygonal cross-section or an elliptical cross-section.

In the illustrated embodiment, a first supply/return conduit 182 is fluidly coupled to the cap end 178 of the front left wing actuator 46, and a second supply return conduit 184 is fluidly coupled to the cap end 178 of the front right center actuator 70. During adjustment of the angle of the disc blades of the front row 36, fluid is provided to the front actuators via one of the first supply/return conduit 182 or the second supply/return conduit 184, and fluid is drained from the front actuators via the other of the first supply/return conduit 182 or the second supply/return conduit 184. As previously discussed, a conduit 186 (e.g., first conduit) extends between the rod end 180 of the front left wing actuator 46 and the rod end 180 of the front left center actuator 54. The conduit 186 is configured to enable fluid flow between the front left wing actuator 46 and the front left center actuator 54. In addition, a conduit 188 (e.g., second conduit) extends between the cap end 178 of the front left center actuator 54 and the cap end 178 of the front right wing actuator 62. The conduit 188 is configured to enable fluid flow between the front left center actuator 54 and the front right wing actuator 62. Furthermore, a conduit 190 (e.g., third conduit) extends between the rod end 180 of the front right wing actuator 62 and the rod end 180 of the front right center actuator 70. The conduit 190 is configured to enable fluid flow between the front right wing actuator 62 and the front right center actuator 70.

Providing fluid to the cap end 178 of the front left wing actuator 46 via the first supply/return conduit 182 drives the respective rod 176 to extend, thereby driving the front left wing disc blade support to pivot in the clockwise direction and driving fluid to move from the rod end 180 of the front left wing actuator 46 to the rod end 180 of the front left center actuator 54. As fluid flows to the rod end 180 of the front left center actuator 54, the respective rod 176 is driven to retract, thereby driving the front left center disc blade support to pivot in the clockwise direction and driving fluid to move from the cap end 178 of the front left center actuator 54 to the cap end 178 of the front right wing actuator 62. As fluid flows to the cap end 178 of the front right wing actuator 62, the respective rod 176 is driven to extend, thereby driving the front right wing disc blade support to pivot in the counter-clockwise direction and driving fluid to move from the rod end 180 of the front right wing actuator 62 to the rod end 180 of the front right center actuator 70. As fluid flows to the rod end 180 of the front right center actuator 70, the respective rod 176 is driven to retract, thereby driving the front right center disc blade support to pivot in the counter-clockwise direction and driving fluid to drain through the second supply/return conduit 184. As a result, each front disc blade support is driven to pivot by providing fluid to the cap end 178 of the front left wing actuator 46. Furthermore, each front disc blade support may be driven to pivot in the opposite direction by providing fluid to the cap end 178 of the front right center actuator 70 via the second supply/return conduit 184. The fluid flows through the front actuators in a direction opposite to the direction disclosed above, and the fluid drains from the cap end 178 of the front left wing actuator 46 via the first supply/return conduit 182.

In the illustrated embodiment, a first supply/return conduit 192 is fluidly coupled to the cap end 178 of the rear left wing actuator 78, and a second supply return conduit 194 is fluidly coupled to the cap end 178 of the rear right center actuator 102. During adjustment of the angle of the disc blades of the rear row 38, fluid is provided to the rear actuators via one of the first supply/return conduit 192 or the second supply/return conduit 194, and fluid is drained from the rear actuators via the other of the first supply/return conduit 192 or the second supply/return conduit 194. As previously discussed, a conduit 196 (e.g., first conduit, second conduit) extends between the rod end 180 of the rear left wing actuator 78 and the rod end 180 of the rear left center actuator 86. The conduit is configured to enable fluid flow between the rear left wing actuator 78 and the rear left center actuator 86. In addition, a conduit 198 (e.g., second conduit) extends between the cap end 178 of the rear left center actuator 86 and the cap end 178 of the rear right wing actuator 94. The conduit 198 is configured to enable fluid flow between the rear left center actuator 86 and the rear right wing actuator 94. Furthermore, a conduit 200 (e.g., third conduit) extends between the rod end 180 of the rear right wing actuator 94 and the rod end 180 of the rear right center actuator 102. The conduit 200 is configured to enable fluid flow between the rear right wing actuator 94 and the rear right center actuator 102.

Providing fluid to the cap end 178 of the rear left wing actuator 78 via the first supply/return conduit 192 drives the respective rod 176 to extend, thereby driving the rear left wing disc blade support to pivot in the counter-clockwise direction and driving fluid to move from the rod end 180 of the rear left wing actuator 78 to the rod end 180 of the rear left center actuator 86. As fluid flows to the rod end 180 of the rear left center actuator 86, the respective rod 176 is driven to retract, thereby driving the rear left center disc blade support to pivot in the counter-clockwise direction and driving fluid to move from the cap end 178 of the rear left center actuator 86 to the cap end 178 of the rear right wing actuator 94. As fluid flows to the cap end 178 of the rear right wing actuator 94, the respective rod 176 is driven to extend, thereby driving the rear right wing disc blade support to pivot in the clockwise direction and driving fluid to move from the rod end 180 of the rear right wing actuator 94 to the rod end 180 of the rear right center actuator 102. As fluid flows to the rod end 180 of the rear right center actuator 102, the respective rod 176 is driven to retract, thereby driving the rear right center disc blade support to pivot in the clockwise direction and driving fluid to drain through the second supply/return conduit 194. As a result, each rear disc blade support is driven to pivot by providing fluid to the cap end 178 of the rear left wing actuator 78. Furthermore, each rear disc blade support may be driven to pivot in the opposite direction by providing fluid to the cap end 178 of the rear right center actuator 102 via the second supply/return conduit 194. The fluid flows through the rear actuators in a direction opposite to the direction disclosed above, and the fluid drains from the cap end 178 of the rear left wing actuator 78 via the first supply/return conduit 192.

In the illustrated embodiment, fluid is provided to the cap ends of the actuators by the respective supply/return conduits. Because the surface area of each piston is greater on the cap end than on the rod end, the actuators apply a greater force for a particular fluid pressure. However, in certain embodiments, for at least one row, fluid may be provided to the rod ends of the actuators by the respective supply/return conduits, thereby reducing the force applied by the actuators, but increasing the movement of the respective rods. In such embodiments, the actuators may be fluidly coupled to one another in the manner disclosed above (e.g., cap end to cap end/rod end to rod end).

In the illustrated embodiment, fluid is provided to the first supply/return conduit 182 of the front row 36 and to the first supply/return conduit 192 of the rear row 38 by a first main supply/return conduit 202. The first main supply/return conduit 202 also receives fluid from the first supply/return conduit 182 of the front row 36 and from the first supply/return conduit 192 of the rear row 38. In addition, fluid is provided to the second supply/return conduit 184 of the front row 36 and to the second supply/return conduit 194 of the rear row 38 by a second main supply/return conduit 204. The second main supply/return conduit 204 also receives fluid from the second supply/return conduit 184 of the front row 36 and from the second supply/return conduit 194 of the rear row 38. As illustrated, the first and second main supply/return conduits are fluidly coupled to a valve assembly 206, and the valve assembly 206 is fluidly coupled to a fluid supply/return 208. The fluid supply/return 208 is configured to provide fluid to the first main supply/return conduit 202 or to the second main supply/return conduit 204, and the fluid supply/return 208 is configured to receive fluid from the first main supply/return conduit 202 or from the second main supply/return conduit 204. The fluid supply/return 208 may include any suitable component(s) configured to provide and receive fluid, such as one or more pumps, one or more reservoirs, one or more valves, one or more accumulators, other suitable component(s), or a combination thereof. Furthermore, the valve assembly 206 includes one or more valves (e.g., two-position valves, two-position proportional control valves, a three-position valve, a three-position proportional control valve, etc.) configured to control fluid flow through the first and second main supply/return conduits. For example, the valve assembly 206 may direct fluid from the fluid supply/return 208 to the first main supply/return conduit 202 and fluid from the second main supply/return conduit 204 to the fluid supply/return 208. The valve assembly may also direct fluid from the fluid supply/return 208 to the second main supply/return conduit 204 and fluid from the first main supply/return conduit 202 to the fluid supply/return 208. Furthermore, in certain embodiments, the valve assembly may control the flow rate of fluid to/from the main supply/return conduits. The fluid disclosed herein may be any suitable fluid, such as hydraulic fluid (e.g., oil) or pneumatic fluid (e.g., air).

In the illustrated embodiment, the disc blade angle adjustment system includes a switching assembly 210 configured to selectively direct fluid flow to the actuators of one row. For example, to enable the valve assembly 206 to control the angles of the sets of disc blades of the front row 36, the switching assembly 210 may establish a fluid connection between the first main supply/return conduit 202 and the first supply/return conduit 182 of the front row 36, and the switching assembly 210 may establish a fluid connection between the second main supply/return conduit 204 and the second supply/return conduit 184 of the front row 36. Concurrently, the switching assembly 210 may block fluid flow between the first main supply/return conduit 202 and the first supply/return conduit 192 of the rear row 38, and the switching assembly 210 may block fluid flow between the second main supply/return conduit 204 and the second supply/return conduit 194 of the rear row 38. In addition, to enable the valve assembly 206 to control the angles of the sets of disc blades of the rear row 38, the switching assembly 210 may establish a fluid connection between the first main supply/return conduit 202 and the first supply/return conduit 192 of the rear row 38, and the switching assembly 210 may establish a fluid connection between the second main supply/return conduit 204 and the second supply/return conduit 194 of the rear row 38. Concurrently, the switching assembly 210 may block fluid flow between the first main supply/return conduit 202 and the first supply/return conduit 182 of the front row 36, and the switching assembly 210 may block fluid flow between the second main supply/return conduit 204 and the second supply/return conduit 184 of the front row 36.

In the illustrated embodiment, the switching assembly 210 includes a first front row valve 212, a second front row valve 214, a first rear row valve 216, and a second rear row valve 218. The first front row valve 212 is configured to selectively block or enable fluid flow between the first main supply/return conduit 202 and the first supply/return conduit 182 of the front row 36, and the second front row valve 214 is configured to selectively block or enable fluid flow between the second main supply/return conduit 204 and the second supply/return conduit 184 of the front row 36. In addition, the first rear row valve 216 is configured to selectively block or enable fluid flow between the first main supply/return conduit 202 and the first supply/return conduit 192 of the rear row 38, and the second rear row valve 218 is configured to selectively block or enable fluid flow between the second main supply/return conduit 204 and the second supply/return conduit 194 of the rear row 38. Accordingly, to enable the valve assembly 206 to control the angles of the sets of disc blades of the front row 36, the first front row valve 212 and the second front row valve 214 may be transitioned to the open position, and the first rear row valve 216 and the second rear row valve 218 may be transitioned to the closed position. In addition, to enable the valve assembly 206 to control the angles of the sets of disc blades of the rear row 38, the first rear row valve 216 and the second rear row valve 218 may be transitioned to the open position, and the first front row valve 212 and the second front row valve 214 may be transitioned to the closed position.

In the illustrated embodiment, each valve of the switching assembly 210 is controlled by a respective solenoid 220. The solenoids may be communicatively coupled to a controller (e.g., electronic controller), thereby enabling the controller to control the positions of the valves of the switching assembly 210. A user interface communicatively coupled to the controller may enable an operator to control the positions of the valves of the switching assembly 210 via input to the user interface. Additionally or alternatively, the controller may automatically control the valves of the switching assembly (e.g., during an automatic disc blade angle adjustment process). Furthermore, in certain embodiments, the solenoids may be electrically coupled to a switch (e.g., within a cab of the work vehicle), thereby enabling an operator to manually control the valves. For example, the switch may include a first position in which the solenoids of the front row valves are activated and the solenoids of the rear row valves are deactivated, a second position in which the solenoids of the rear row valves are activated and the solenoids of the front row valves are deactivated, and a third position in which the solenoids of the front row valves and the solenoids of the rear row valves are deactivated. While the valves of the switching assembly 210 are controlled by solenoids 220 in the illustrated embodiment, in other embodiments, at least one valve of the switching assembly may be controlled by other suitable type(s) of actuator(s) (e.g., alone or in combination with the solenoid), such as pneumatic actuator(s), hydraulic actuator(s), mechanical actuator(s), other suitable type(s) of actuator(s), or a combination thereof. For example, in certain embodiments, the valves of the switching assembly may be controlled by hydraulic actuators, and an operator may control hydraulic fluid flow to the hydraulic actuators by controlling valve(s) of the work vehicle (e.g., a valve of a hydraulic remote, a valve configured to control unfolding of the wings of the frame, etc.). In the illustrated embodiment, each valve of the switching assembly is biased to the closed position, and the actuator (e.g., solenoid) is configured to drive the valve to the open position. However, in other embodiments, at least one valve may be biased to the open position, and/or at least one valve may be driven to transition between positions by a pair of actuators.

The switching assembly 210 enables the angles of the sets of disc blades of the front and rear rows to be adjusted independently via a single valve assembly (e.g., via a single valve of the single valve assembly), thereby reducing the number of valve assemblies (e.g., valves) used for adjusting the angles of the sets of disc blades. For example, the sets of disc blades of the front row may be adjusted to a different angle than the sets of disc blades of the rear row. In addition, the switching assembly 210 enables the angles of the sets of disc blades of the front and rear rows to be adjusted with reduced fluid flow/pressure (e.g., as compared to a disc blade angle adjustment system in which all of the actuators are fluidly coupled to one another), thereby reducing energy usage. The switching assembly 210 also facilitates the use of smaller actuators due to the lower total load experienced by the actuators of each row (e.g., as compared to a disc blade angle adjustment system in which all of the actuators are fluidly coupled to one another, in which the actuators experience a higher total load), thereby reducing the cost of the disc blade angle adjustment system. Furthermore, while the angles of the sets of disc blades are not being adjusted, each valve of the switching assembly 210 may be transitioned to the closed position, thereby reducing fluid pressure on the valve assembly 206. As a result, fluid leakage through the valve assembly may be reduced, thereby enabling the actuators to effectively maintain the angles of the sets of disc blades during operation of the tillage implement. Furthermore, while the switching assembly 210 is configured to selectively direct fluid flow to the actuators of the front row 36 or to the actuators of the rear row 38 in the illustrated embodiment, in embodiments having additional rows, the switching assembly may be configured to selectively direct fluid to the actuators of each row. Furthermore, in embodiments having a single row of disc blades, the switching assembly may be omitted. In addition, in certain embodiments, the actuators of the front row and the actuators of the rear row may be fluidly coupled to one another. For example, the first supply/return conduit of the rear row may be fluidly coupled to the second supply/return conduit of the front row. In such embodiments, the switching assembly may be omitted. Furthermore, in certain embodiments, the actuators of the front row may be fluidly coupled to a first valve assembly, and the actuators of the second row may be fluidly coupled to a second valve assembly. In such embodiments, each valve assembly may be configured to control the actuators of the respective row, and the switching assembly may be omitted.

In certain embodiments, the valve assembly and the fluid supply/return are elements of the work vehicle (e.g., tractor, etc.) that tows the tillage implement, and the switching assembly is an element of the tillage implement. In such embodiments, connectors (e.g., quick connectors) may be disposed along the main supply/return conduits between the valve assembly and the switching assembly to facilitate selectively coupling and uncoupling the work vehicle and the tillage implement. Furthermore, in certain embodiments, the valve assembly may be an element of the tillage implement. In such embodiments, connectors (e.g., quick connectors) may be located along suitable conduits to facilitate coupling and uncoupling the work vehicle and the tillage implement. In addition, in certain embodiments, the valve assembly may be manually controlled (e.g., via mechanical actuator(s), via hydraulic actuator(s), via pneumatic actuator(s), via electrical actuator(s), etc.) and/or automatically controlled (e.g., via a controller, etc.).

In the illustrated embodiment, each actuator of the disc blade angle adjustment system is a re-phasing actuator. Re-phasing actuators are configured to enable the actuators to remain synchronized during operation of the disc blade angle adjustment system. For example, during operation, fluid may leak across the piston seal(s) of each actuator. Each re-phasing actuator enables the fluid to bypass the piston seal(s) so fluid replenishes any leaked fluid (e.g., at the cap end or at the rod end). In embodiments in which the actuators utilize hydraulic fluid, the possibility of introducing air into the hydraulic system may be substantially reduced, and hydraulic fluid leaked across the piston seal(s) may be replenished to enable the actuators to remain synchronized. While each actuator of the disc blade angle adjustment system is a re-phasing actuator in the illustrated embodiment, in other embodiments (e.g., in embodiments in which the actuators utilize air), at least one actuator (e.g., each actuator of the disc blade angle adjustment system) may not be a re-phasing actuator.

As previously discussed, each actuator of the front and rear rows includes a single rod extending from the piston in one direction. As a result, the cost of each front row/rear row actuator may be reduced, and the longevity of each front row/rear row actuator may be increased (e.g., due to fewer seals), as compared to an actuator having a first rod extending in a first direction from the piston and a second rod extending in a second direction, opposite the first direction, from the piston. In addition, because each actuator does not include a second rod, the size of the actuator may be reduced, thereby increasing the mounting options for the actuator. However, in certain embodiments, at least one actuator may include two rods extending in opposite directions from the piston.

As previously discussed, conduits extend between the actuators of the front row, and conduits extend between the actuators of the rear row. In certain embodiments, each conduit extends directly between two respective actuators. As used herein with regard to the conduits extending between respective actuators, “directly between” indicates that no valve or flow splitter is disposed along the conduit. However, in certain embodiments, at least one valve and/or at least one flow splitter may be disposed along at least one conduit extending between two respective actuators.

With regard to one direction of fluid flow, the actuators of the front row and the actuators of the rear row are arranged in respective series, in which each series has the order of the left wing actuator, the left center actuator, the right wing actuator, and the right center actuator. However, in other embodiments, the actuators of at least one row may be arranged in a series having another suitable order. In such embodiments, the respective first supply/return conduit may be coupled to the first actuator in the series, and the respective second supply/return conduit may be coupled to the last actuator in the series. Depending on the arrangement of the actuators, each supply/return line may be coupled to the rod end or the cap end of the first/last actuator in the series. Furthermore, the rod ends or the cap ends of sequential actuators in the series may be fluidly coupled to one another by a respective conduit. In addition, while each series of actuators corresponds to a respective row in the illustrated embodiment, in other embodiments, at least one series of actuators may include one or more actuators in one row and one or more actuators in another row. Additionally or alternatively, at least one series of actuators may include one or more actuators from one area of the tillage implement and one or more actuators from another area of the tillage implement. In addition, while each series of actuators includes actuator(s) positioned at each section of the tillage implement frame in the illustrated embodiment, in other embodiments, at least one series of actuators may include actuators positioned at one or two frame sections. For example, in certain embodiments, each actuator of a series may be positioned at the left wing section, the right wing section, or the center section of the tillage implement frame. In embodiments in which the tillage implement frame has more or fewer frame sections, the actuators of a series may be positioned at any frame section or any combination of frame sections. Furthermore, while the actuators of each series are fluidly coupled to one another cap end to cap end/rod end to rod end in the illustrated embodiment, in other embodiments, at least one series of actuators may include at least two actuators fluidly coupled to one another rod end to cap end. In embodiments having multiple series of actuators, the switching assembly may be configured to selectively direct fluid flow to the actuators of each series.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A disc blade angle adjustment system for a tillage implement, comprising:
a first actuator comprising a cylinder, a piston disposed within the cylinder, and a single rod extending from the piston, wherein the first actuator is configured to couple to a frame of the tillage implement and to a first disc blade support, the first disc blade support is configured to pivotally couple to the frame at a first pivot point, the first disc blade support is configured to support a first plurality of disc blades, and the first actuator is configured to drive the first disc blade support to pivot relative to the frame to control a first angle between the first plurality of disc blades and a direction of travel of the tillage implement;
a second actuator comprising a cylinder, a piston disposed within the cylinder of the second actuator, and a single rod extending from the piston of the second actuator, wherein the second actuator is configured to couple to the frame of the tillage implement and to a second disc blade support, the second disc blade support is configured to pivotally couple to the frame at a second pivot point, the second disc blade support is configured to support a second plurality of disc blades, the first and second disc blade supports are configured to pivot independently of one another, and the second actuator is configured to drive the second disc blade support to pivot relative to the frame to control a second angle between the second plurality of disc blades and the direction of travel of the tillage implement; and
a conduit extending between a cap end of the first actuator and a cap end of the second actuator or between a rod end of the first actuator and a rod end of the second actuator, wherein the conduit is configured to enable fluid flow between the first and second actuators;
wherein a cross-sectional area of the rod of the first actuator is substantially equal to a cross-sectional area of the rod of the second actuator, and an internal cross-sectional area of the cylinder of the first actuator is substantially equal to an internal cross-sectional area of the cylinder of the second actuator; and
wherein the first actuator is configured to drive the first disc blade support to pivot in a first direction about the first pivot point in response to extension of the rod of the first actuator, the first actuator is configured to drive the first disc blade support to pivot in a second direction about the first pivot point, opposite the first direction, in response to retraction of the rod of the first actuator, the second actuator is configured to drive the second disc blade support to pivot in the second direction about the second pivot point in response to extension of the rod of the second actuator, and the second actuator is configured to drive the second disc blade support to pivot in the first direction about the second pivot point in response to retraction of the rod of the second actuator.

2. The disc blade angle adjustment system of claim 1, wherein the first plurality of disc blades and the second plurality of disc blades are in the same row.

3. The disc blade angle adjustment system of claim 1, wherein the first actuator is configured to couple to a wing section of the frame, the first disc blade support is configured to pivotally couple to the wing section of the frame, the second actuator is configured to couple to a center section of the frame, and the second disc blade support is configured to pivotally couple to the center section of the frame.

4. The disc blade angle adjustment system of claim 3, comprising:
a third actuator comprising a cylinder, a piston disposed within the cylinder of the third actuator, and a single rod extending from the piston of the third actuator, wherein the third actuator is configured to couple to the frame of the tillage implement and to a third disc blade support, the third disc blade support is configured to pivotally couple to the frame at a third pivot point, the third disc blade support is configured to support a third plurality of disc blades, and the third actuator is configured to drive the third disc blade support to pivot relative to the frame to control a third angle between the third plurality of disc blades and the direction of travel of the tillage implement;
a fourth actuator comprising a cylinder, a piston disposed within the cylinder of the fourth actuator, and a single rod extending from the piston of the fourth actuator, wherein the fourth actuator is configured to couple to the frame of the tillage implement and to a fourth disc blade support, the fourth disc blade support is configured to pivotally couple to the frame at a fourth pivot point, the fourth disc blade support is configured to support a fourth plurality of disc blades, the first, second, third, and fourth disc blade supports are configured to pivot independently of one another, and the fourth actuator is configured to drive the fourth disc blade support to pivot relative to the frame to control a fourth angle between the fourth plurality of disc blades and the direction of travel of the tillage implement;
a second conduit extending between the cap end of the second actuator and a cap end of the third actuator, wherein the second conduit is configured to enable fluid flow between the second and third actuators; and
a third conduit extending between a rod end of the third actuator and a rod end of the fourth actuator, wherein the third conduit is configured to enable fluid flow between the third and fourth actuators;
wherein the conduit extends between the rod end of the first actuator and the rod end of the second actuator;
wherein the cross-sectional area of the rod of the first actuator, the cross-sectional area of the rod of the second actuator, a cross-sectional area of the rod of the third actuator, and a cross-sectional area of the rod of the fourth actuator are substantially equal to one another, and the internal cross-sectional area of the cylinder of the first actuator, the internal cross-sectional area of the cylinder of the second actuator, an internal cross-sectional area of the cylinder of the third actuator, and an internal cross-sectional area of the cylinder of the fourth actuator are substantially equal to one another; and
wherein the third actuator is configured to drive the third disc blade support to pivot in the second direction about the third pivot point in response to extension of the rod of the third actuator, the third actuator is configured to drive the third disc blade support to pivot in the first direction about the third pivot point in response to retraction of the rod of the third actuator, the fourth actuator is configured to drive the fourth disc blade support to pivot in the first direction about the fourth pivot point in response to extension of the rod of the fourth actuator, and the fourth actuator is configured to drive the fourth disc blade support to pivot in the second direction about the fourth pivot point in response to retraction of the rod of the fourth actuator.

5. The disc blade angle adjustment system of claim 4, wherein the third actuator is configured to couple to a second wing section of the frame, the third disc blade support is configured to pivotally couple to the second wing section of the frame, the fourth actuator is configured to couple to the center section of the frame, and the fourth disc blade support is configured to pivotally couple to the center section of the frame.

6. The disc blade angle adjustment system of claim 5, wherein the first plurality of disc blades, the second plurality of disc blades, the third plurality of disc blades, and the fourth plurality of disc blades are in the same row.

7. The disc blade angle adjustment system of claim 1, wherein the first and second actuators are substantially identical to one another.

8. The disc blade angle adjustment system of claim 1, comprising:
a third actuator comprising a cylinder, a piston disposed within the cylinder of the third actuator, and a single rod extending from the piston of the third actuator, wherein the third actuator is configured to couple to the frame of the tillage implement and to a third disc blade support, the third disc blade support is configured to pivotally couple to the frame at a third pivot point, the third disc blade support is configured to support a third plurality of disc blades, and the third actuator is configured to drive the third disc blade support to pivot relative to the frame to control a third angle between the third plurality of disc blades and the direction of travel of the tillage implement;
a fourth actuator comprising a cylinder, a piston disposed within the cylinder of the fourth actuator, and a single rod extending from the piston of the fourth actuator, wherein the fourth actuator is configured to couple to the frame of the tillage implement and to a fourth disc blade support, the fourth disc blade support is configured to pivotally couple to the frame at a fourth pivot point, the fourth disc blade support is configured to support a fourth plurality of disc blades, the first, second, third, and fourth disc blade supports are configured to pivot independently of one another, and the fourth actuator is configured to drive the fourth disc blade support to pivot relative to the frame to control a fourth angle between the fourth plurality of disc blades and the direction of travel of the tillage implement; and
a second conduit extending between a cap end of the third actuator and a cap end of the fourth actuator or between a rod end of the third actuator and a rod end of the fourth actuator, wherein the second conduit is configured to enable fluid flow between the third and fourth actuators;
wherein the first plurality of disc blades and the second plurality of disc blades are in a front row, and the third plurality of disc blades and the fourth plurality of disc blades are in a rear row;
wherein a cross-sectional area of the rod of the third actuator is substantially equal to a cross-sectional area of the rod of the fourth actuator, and an internal cross-sectional area of the cylinder of the third actuator is substantially equal to an internal cross-sectional area of the cylinder of the fourth actuator; and
wherein the third actuator is configured to drive the third disc blade support to pivot in the second direction about the third pivot point in response to extension of the rod of the third actuator, the third actuator is configured to drive the third disc blade support to pivot in the first direction about the third pivot point in response to retraction of the rod of the third actuator, the fourth actuator is configured to drive the fourth disc blade support to pivot in the first direction about the fourth pivot point in response to extension of the rod of the fourth actuator, and the fourth actuator is configured to drive the fourth disc blade support to pivot in the second direction about the fourth pivot point in response to retraction of the rod of the fourth actuator.

9. The disc blade angle adjustment system of claim 8, comprising a switching assembly configured to selectively enable fluid flow to the first actuator and to block fluid flow to the third actuator, or to enable fluid flow to the third actuator and to block fluid flow to the first actuator.

10. A tillage implement, comprising:
a frame;
a first disc blade support pivotally coupled to the frame at a first pivot point, wherein the first disc blade support is configured to support a first plurality of disc blades;
a second disc blade support pivotally coupled to the frame at a second pivot point, wherein the second disc blade support is configured to support a second plurality of disc blades, and the first and second disc blade supports are configured to pivot independently of one another; and
a disc blade angle adjustment system, comprising:
a first actuator comprising a cylinder, a piston disposed within the cylinder, and a single rod extending from the piston, wherein the first actuator is coupled to the frame and to the first disc blade support, and the first actuator is configured to drive the first disc blade support to pivot relative to the frame to control a first angle between the first plurality of disc blades and a direction of travel of the tillage implement;
a second actuator comprising a cylinder, a piston disposed within the cylinder of the second actuator, and a single rod extending from the piston of the second actuator, wherein the second actuator is coupled to the frame and to the second disc blade support, and the second actuator is configured to drive the second disc blade support to pivot relative to the frame to control a second angle between the second plurality of disc blades and the direction of travel of the tillage implement; and
a conduit extending between a cap end of the first actuator and a cap end of the second actuator or between a rod end of the first actuator and a rod end of the second actuator, wherein the conduit is configured to enable fluid flow between the first and second actuators;
wherein a cross-sectional area of the rod of the first actuator is substantially equal to a cross-sectional area of the rod of the second actuator, and an internal cross-sectional area of the cylinder of the first actuator is substantially equal to an internal cross-sectional area of the cylinder of the second actuator; and
wherein the first actuator is configured to drive the first disc blade support to pivot in a first direction about the first pivot point in response to extension of the rod of the first actuator, the first actuator is configured to drive the first disc blade support to pivot in a second direction about the first pivot point, opposite the first direction, in response to retraction of the rod of the first actuator, the second actuator is configured to drive the second disc blade support to pivot in the second direction about the second pivot point in response to extension of the rod of the second actuator, and the second actuator is configured to drive the second disc blade support to pivot in the first direction about the second pivot point in response to retraction of the rod of the second actuator.

11. The tillage implement of claim 10, wherein the first plurality of disc blades and the second plurality of disc blades are in the same row.

12. The tillage implement of claim 10, wherein the frame comprises a wing section and a center section pivotally coupled to one another, the first actuator is coupled to the wing section, the first disc blade support is pivotally coupled to the wing section, the second actuator is coupled to the center section, and the second disc blade support is pivotally coupled to the center section.

13. The tillage implement of claim 12, wherein the frame comprises a second wing section pivotally coupled to the center section;
wherein the tillage implement comprises:
a third disc blade support pivotally coupled to the second wing section at a third pivot point, wherein the third disc blade support is configured to support a third plurality of disc blades; and
a fourth disc blade support pivotally coupled to the center section at a fourth pivot point, wherein the fourth disc blade support is configured to support a fourth plurality of disc blades; and the first, second, third, and fourth disc blade supports are configured to pivot independently of one another; and
wherein the disc blade angle adjustment system comprises:
a third actuator comprising a cylinder, a piston disposed within the cylinder of the third actuator, and a single rod extending from the piston of the third actuator, wherein the third actuator is coupled to the second wing section and to the third disc blade support, and the third actuator is configured to drive the third disc blade support to pivot relative to the second wing section to control a third angle between the third plurality of disc blades and the direction of travel of the tillage implement;
a fourth actuator comprising a cylinder, a piston disposed within the cylinder of the fourth actuator, and a single rod extending from the piston of the fourth actuator, wherein the fourth actuator is coupled to the center section and to the fourth disc blade support, and the fourth actuator is configured to drive the fourth disc blade support to pivot relative to the center section to control a fourth angle between the fourth plurality of disc blades and the direction of travel of the tillage implement;
a second conduit extending between the cap end of the second actuator and a cap end of the third actuator, wherein the second conduit is configured to enable fluid flow between the second and third actuators; and
a third conduit extending between a rod end of the third actuator and a rod end of the fourth actuator, wherein the third conduit is configured to enable fluid flow between the third and fourth actuators;
wherein the conduit extends between the rod end of the first actuator and the rod end of the second actuator;
wherein the cross-sectional area of the rod of the first actuator, the cross-sectional area of the rod of the second actuator, a cross-sectional area of the rod of the third actuator, and a cross-sectional area of the rod of the fourth actuator are substantially equal to one another, and the internal cross-sectional area of the cylinder of the first actuator, the internal cross-sectional area of the cylinder of the second actuator, an internal cross-sectional area of the cylinder of the third actuator, and an internal cross-sectional area of the cylinder of the fourth actuator are substantially equal to one another; and
wherein the third actuator is configured to drive the third disc blade support to pivot in the second direction about the third pivot point in response to extension of the rod of the third actuator, the third actuator is configured to drive the third disc blade support to pivot in the first direction about the third pivot point in response to retraction of the rod of the third actuator, the fourth actuator is configured to drive the fourth disc blade support to pivot in the first direction about the fourth pivot point in response to extension of the rod of the fourth actuator, and the fourth actuator is configured to drive the fourth disc blade support to pivot in the second direction about the fourth pivot point in response to retraction of the rod of the fourth actuator.

14. The tillage implement of claim 13, wherein the first plurality of disc blades, the second plurality of disc blades, the third plurality of disc blades, and the fourth plurality of disc blades are in the same row.

15. The disc blade angle adjustment system of claim 10, wherein the first and second actuators are substantially identical to one another.

16. A disc blade angle adjustment system for a tillage implement, comprising:
a first actuator comprising a cylinder, a piston disposed within the cylinder, and a single rod extending from the piston, wherein the first actuator is configured to couple to a frame of the tillage implement and to a first disc blade support, the first disc blade support is configured to pivotally couple to the frame at a first pivot point, the first disc blade support is configured to support a first plurality of disc blades, and the first actuator is configured to drive the first disc blade support to pivot relative to the frame to control a first angle between the first plurality of disc blades and a direction of travel of the tillage implement;
a second actuator comprising a cylinder, a piston disposed within the cylinder of the second actuator, and a single rod extending from the piston of the second actuator, wherein the second actuator is configured to couple to the frame of the tillage implement and to a second disc blade support, the second disc blade support is configured to pivotally couple to the frame at a second pivot point, the second disc blade support is configured to support a second plurality of disc blades, the first and second disc blade supports are configured to pivot independently of one another, and the second actuator is configured to drive the second disc blade support to pivot relative to the frame to control a second angle between the second plurality of disc blades and the direction of travel of the tillage implement; and
a conduit extending between a cap end of the first actuator and a cap end of the second actuator or between a rod end of the first actuator and a rod end of the second actuator, wherein the conduit is configured to enable fluid flow between the first and second actuators;
wherein the first actuator is configured to drive the first disc blade support to pivot in a first direction about the first pivot point in response to extension of the rod of the first actuator, the first actuator is configured to drive the first disc blade support to pivot in a second direction about the first pivot point, opposite the first direction, in response to retraction of the rod of the first actuator, the second actuator is configured to drive the second disc blade support to pivot in the second direction about the second pivot point in response to extension of the rod of the second actuator, and the second actuator is configured to drive the second disc blade support to pivot in the first direction about the second pivot point in response to retraction of the rod of the second actuator; and
wherein the first actuator and the second actuator are configured to drive the first disc blade support and the second disc blade support to pivot, respectively, such that the first angle and the second angle vary substantially equally in response to receiving fluid at the first actuator.

17. The disc blade angle adjustment system of claim 16, wherein the first plurality of disc blades and the second plurality of disc blades are in the same row.

18. The disc blade angle adjustment system of claim 16, wherein the first actuator is configured to couple to a wing section of the frame, the first disc blade support is configured to pivotally couple to the wing section of the frame, the second actuator is configured to couple to a center section of the frame, and the second disc blade support is configured to pivotally couple to the center section of the frame.

19. The disc blade angle adjustment system of claim 16, comprising:
a third actuator comprising a cylinder, a piston disposed within the cylinder of the third actuator, and a single rod extending from the piston of the third actuator, wherein the third actuator is configured to couple to the frame of the tillage implement and to a third disc blade support, the third disc blade support is configured to pivotally couple to the frame at a third pivot point, the third disc blade support is configured to support a third plurality of disc blades, and the third actuator is configured to drive the third disc blade support to pivot relative to the frame to control a third angle between the third plurality of disc blades and the direction of travel of the tillage implement;
a fourth actuator comprising a cylinder, a piston disposed within the cylinder of the fourth actuator, and a single rod extending from the piston of the fourth actuator, wherein the fourth actuator is configured to couple to the frame of the tillage implement and to a fourth disc blade support, the fourth disc blade support is configured to pivotally couple to the frame at a fourth pivot point, the fourth disc blade support is configured to support a fourth plurality of disc blades, the first, second, third, and fourth disc blade supports are configured to pivot independently of one another, and the fourth actuator is configured to drive the fourth disc blade support to pivot relative to the frame to control a fourth angle between the fourth plurality of disc blades and the direction of travel of the tillage implement; and
a second conduit extending between a cap end of the third actuator and a cap end of the fourth actuator or between a rod end of the third actuator and a rod end of the fourth actuator, wherein the second conduit is configured to enable fluid flow between the third and fourth actuators;
wherein the first plurality of disc blades and the second plurality of disc blades are in a front row, and the third plurality of disc blades and the fourth plurality of disc blades are in a rear row;
wherein the third actuator is configured to drive the third disc blade support to pivot in the second direction about the third pivot point in response to extension of the rod of the third actuator, the third actuator is configured to drive the third disc blade support to pivot in the first direction about the third pivot point in response to retraction of the rod of the third actuator, the fourth actuator is configured to drive the fourth disc blade support to pivot in the first direction about the fourth pivot point in response to extension of the rod of the fourth actuator, and the fourth actuator is configured to drive the fourth disc blade support to pivot in the second direction about the fourth pivot point in response to retraction of the rod of the fourth actuator; and
wherein the third actuator and the fourth actuator are configured to drive the third disc blade support and the fourth disc blade support to pivot, respectively, such that the third angle and the fourth angle vary substantially equally in response to receiving fluid at the third actuator.

20. The disc blade angle adjustment system of claim 19, comprising a switching assembly configured to selectively enable fluid flow to the first actuator and to block fluid flow to the third actuator, or to enable fluid flow to the third actuator and to block fluid flow to the first actuator.
